(19) United States
(12) Patent Application Publication
(10) Pub. No.: US 2025/0379890 A1
(43) Pub. Date: Dec. 11, 2025

(54) SYSTEMS, METHODS AND APPARATUS FOR TRANSPORT LAYER SECURITY (TLS) FOR THE INTERNET AND SIXTH GENERATION (6G) COMMUNICATIONS

(71) Applicant: CABLE TELEVISION LABORATORIES, INC., Louisville, CO (US)

(72) Inventor: Tao Wan, Ottawa (CA)

(21) Appl. No.: 19/309,110

(22) Filed: Aug. 25, 2025

Related U.S. Application Data
(63) Continuation-in-part of application No. 19/203,639, filed on May 9, 2025.
(60) Provisional application No. 63/644,961, filed on May 9, 2024.

(51) Int. Cl. H04L 9/40; H04L 9/08

(52) U.S. Cl. CPC H04L 63/166; H04L 9/08

(57) ABSTRACT

Transport layer security (TLS) for the Internet and Sixth Generation (6G) Communications is described herein. A first network node encapsulates a transport layer security (TLS) ClientHello message, a client key share, and one or more other TLS extensions in a first hypertext transfer protocol (HTTP) POST request message. Then, the first network node sends, to a second network node, the first HTTP POST request message. The second network node forwards the first HTTP POST request message to a third network node. The third network node encapsulates a TLS ServerHello message, a server key share, a TLS Server Finished message, and one or more other TLS server generated messages in a first HTTP 200 OK status response message. The third network node sends the first HTTP 200 OK status response message to the second network node, which forwards the message to the first network node.

### CROSS-REFERENCE TO RELATED APPLICATIONS

This application is a continuation-in-part of U.S. patent application Ser. No. 19/203,639, filed May 9, 2025, which claims the benefit of U.S. Provisional Application No. 63/644,961, filed May 9, 2024, the contents of which are incorporated herein by reference.

### BACKGROUND

In Third Generation Partnership Project (3GPP) communication, service based interfaces (SBIs) include protection at the network layer or transport layer. Accordingly, network functions support the mutually authenticated transport layer security (TLS) protocol and hypertext transfer protocol secure (HTTPS). The identities in the end entity certificates are used for authentication and policy checks. Network functions shall support both server-side and client-side certificates. TLS is used for transport protection within a public land mobile network (PLMN) unless security is provided by other means. Further, TLS may be used for protection between a network function and a Security Edge Protection Proxy (SEPP). Also, TLS (such as version 1.3 or earlier) is traditionally layered over transmission control protocol (TCP), with TLS handshake messages carried directly over a TCP connection between peers.

PRotocol for N32 INterconnect Security (PRINS) is an application layer security protocol for the roaming interface N32 to provide end-to-end message protection between a Visiting PLMN Security Edge Protection Proxy (vSEPP) and home PLMN SEPP (hSEPP). PRINS is based on the security requirements and design principles for application layer security provided to 3GPP by the Global System for Mobile communications Association (GSMA), including diameter end-to-end subgroup (DESS) requirements. PRINS satisfies the end-to-end security requirements from GSMA, which is an important security improvement in Fifth Generation (5G) roaming over Fourth (4G) roaming.

The 5G roaming interface, N32, consists of N32-f, an interface for forwarding signaling messages between network functions in the two PLMNs, and N32-c, a control interface for managing N32-f, including negotiating security protection related parameters for N32-f/PRINS.

In PRINS, N32-c is an HTTP/2 connection within an end-to-end TLS tunnel between vSEPP and hSEPP. This end-to-end N32-c TLS tunnel is established over roaming intermediaries (RIs) via HTTP CONNECT, which turns RI HTTP proxies into TCP proxies, allowing TCP payloads carrying TLS messages to be exchanged directly between vSEPP and hSEPP.

### SUMMARY

Methods and apparatus for session management for transport layer security (TLS) over hypertext transfer protocol (HTTP) for the Internet and Sixth Generation (6G) communications are provided herein. In an example, a first network node encapsulates a transport layer security (TLS) ClientHello message and a client key share in a first HTTP POST request message. Then, the first network node sends, to a second network node, the first HTTP POST request message.

Additionally or alternatively, the second network node forwards the first HTTP POST request message to a third network node. The third network node encapsulates a TLS ServerHello message, a server key share, a TLS Server Finished message, and one or more other TLS server generated messages in a first HTTP 200 OK status response message. The third network node sends the first HTTP 200 OK status response message to the second network node, which forwards the message to the first network node.

Additionally or alternatively, the first network node encapsulates a Client Certificate message, a CertificateVerify message, and a TLS Client Finished message, in a second HTTP POST request message. Then, the first network node sends, to a second network node, the second HTTP POST request message.

Additionally or alternatively, the second network node forwards the second HTTP POST request message to a third network node. The third network node generates a second HTTP 200 OK status response message. The third network node sends the second HTTP 200 OK status response message to the second network node, which forwards the message to the first network node.

Additionally or alternatively, the first network node is a client, the second network node is a proxy, and third network node is a server.

In another example, a first network node generates a TLS ClientHello message, Further, the first network node encapsulate the TLS ClientHello message, a client key share, and one or more other TLS extensions in a first HTTP request message. Also, first network node sends, to a second network node, the first HTTP request message.

Additionally or alternatively, the second network node forwards the first HTTP request message to a third network node. The third network node forwards, to a fourth network node, the first HTTP request message.

The fourth network node generates a TLS ServerHello message. Also, the fourth network node encapsulates the TLS ServerHello message, a server key share, a TLS Server Finished message, and one or more other TLS server generated messages in a first HTTP response message. Moreover, the fourth network node sends, to the third network node, the first HTTP response message.

Additionally or alternatively, the third network node forwards, to the second network node, the first HTTP response message. The second network node forwards, to the first network node, the first HTTP response message.

Additionally or alternatively, the first network node generates, a TLS Client Finished message. Further, the first network node encapsulates a Client Certificate message, a CertificateVerify messages, and the TLS Client Finished message in a second HTTP request message. Moreover, the first network node sends, to the second network node, the second HTTP request message.

Additionally or alternatively, the second network node forwards, to the third network node, the second HTTP request message. The third network node forwards, to the fourth network node, the second HTTP request message. Moreover, the fourth network node sends, to the third network node, a second HTTP response message.

Additionally or alternatively, the third network node forwards, to the second network node, the second HTTP response message. The second network node forwards, to the first network node, the second HTTP response message.

The first network node performs key exporting. Further, the fourth network node performs key exporting.

Additionally or alternatively, the first network node is a consumer's Security Edge Protection Proxy (SEPP) (CSEPP). Additionally or alternatively, the second network node is a first roaming intermediary (RI) Proxy. Additionally or alternatively, the third network node is a second RI Proxy. Additionally or alternatively, the fourth network node is a producer's SEPP (pSEPP).

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 is an illustration of an example device;

FIG. 2 illustrates an example communication system;

FIG. 3 illustrates an example of a functional split between a next generation radio access network (NG-RAN) and Fifth Generation (5G) core (5GC);

FIG. 4 illustrates an example of a protocol stack for a user plane and a control plane;

FIG. 5 illustrates an example of a security capability negotiation between Security Edge Protection Proxies (SEPPs);

FIG. 6 illustrates an example of the architecture for PRotocol for N32 INterconnect Security (PRINS);

FIG. 7 illustrates an example of the architecture for PRINS version 2 (v2) with N32-c establishment;

FIG. 8 illustrates an example of the architecture for PRINS v2 N32-c;

FIG. 9 illustrates an example of a key exchange procedure initiated by a consumer's SEPP (CSEPP) in PRINS v2;

FIG. 10 illustrates an example of a PRINS v2 cipher suite exchange procedure;

FIG. 11 illustrates an example message flow of a transport layer security (TLS) handshake over hypertext transfer protocol (HTTP); and

FIG. 12 illustrates an example of the architecture for a TLS handshake procedure initiated by a cSEPP.

### DETAILED DESCRIPTION

The underlying principle of a communication system is to enable one or more devices to communicate with one or more other devices. At a basic level, each device may need some basic components to operate. Any device referenced herein, including the hardware (e.g., virtual or physical) to run a function, software entity, application, or the like, may be understood to have at least one or more of the following components (e.g., where there may be one or more of each component): a processor, a transceiver (e.g., which may or may not be integrated with the processor), an input (e.g., microphone, keyboard, mouse, etc.), an output (e.g., port for outputting display signals, a display, a touch screen, a printer, etc.), a power source, a positioning chip (e.g., GPS, GLONASS, etc., which may or may not be integrated with the processor and/or transceiver), button (e.g., for controlling the specific function of one or more aspects of the device). These components may be operably connected to one another, meaning that there may be a direct connection or an indirect connection to one or more of the components.

A User Equipment (UE) may be interchangeable with a station (STA), a mobile station, a fixed or mobile subscriber unit, a subscription-based unit, a pager, a cellular telephone, a personal digital assistant (PDA), a smartphone, a laptop, a netbook, a computer, a server, a functional entity (e.g., virtual and/or physical) a wireless sensor, a hotspot or Mi-Fi device, an Internet of Things (IoT) device, a watch or other wearable, a head-mounted display (HMD), a vehicle, a drone, or the like.

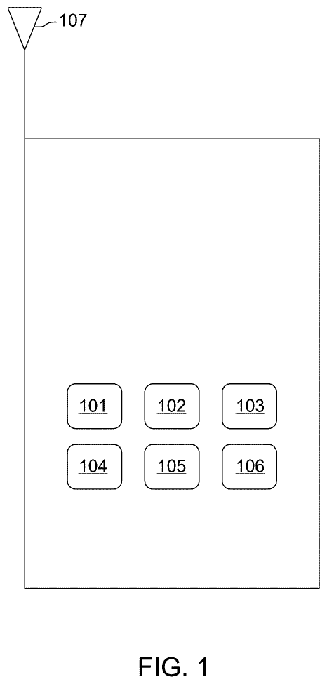

FIG. 1 is an illustration of an example device. In one case, the device may be a UE suited for mobile operation. In this example, the UE may have a processor 101, a transceiver 102, a touchscreen 103, a power source 104 (e.g., a battery), a GPS 105, one or more other components 106 (e.g., as described herein), and/or an antenna 107.

Generally, a processor may be any kind of processor, such as a processor capable of carrying out one or more of the techniques described herein. A transceiver may be configured to transmit and receive signals. In one case, there may be a separate receiver and transmitter. A transceiver may be connected to one or more antennas (e.g., MIMO technology). A transceiver may be configured to transmit RF signals. In one case, a transceiver may be configured to transmit light signals (e.g., IR, UV, laser, etc.). A transceiver may be configured to send/receive more than one type of RF signal (e.g., different radio access technologies for one transceiver, or multiple transceivers each dedicated to a specific radio access technology). A transceiver may be configured to modulate signals for transmission, and demodulate signals for reception. The UE may be capable of full duplex operation, where there is transmission and reception of some or all signals may be concurrent and/or simultaneous, for example, different timing/spacing for uplink (UL) or downlink (DL).

Different radio access technologies may be used with one or more transceivers (e.g., 802.11, WCDMA, CDMA2000, GSM, LTE, LTE-A, LTE-A Pro, NR etc.).

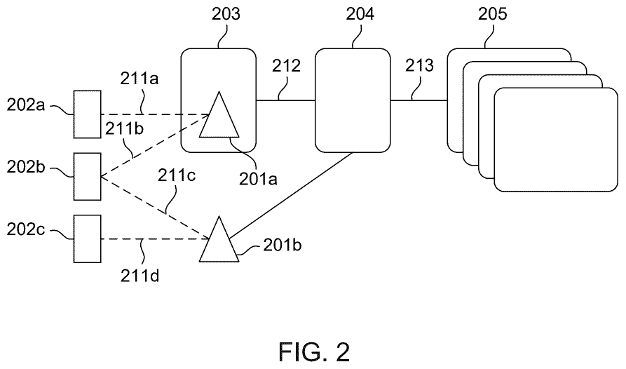

FIG. 2 illustrates an example communication system. This example may be used to illustrate multiple wireless protocols. For all wireless protocols, there may be mobile or stationary devices (e.g., 202a, 202b, 202c, such as a UE) that connect to a base station device 201a and/or 201b. In one case, this may enable a mobile device to connect to a service (e.g., a remote server) or data network (e.g., internet).

In one case, the base stations (201a, 201b) may be equivalent to, and/or interchangeable with, a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, transmission receive point (TRP), network (NW), RP (reception point), RRH (radio remote head), DA (distributed antenna), BS (base station), a sector (of a BS), and a cell (e.g., a geographical cell area served by a BS). Each base station may be representative of more than one base station (e.g., multiple transmission reception points).

A base station may be a network node. Other network nodes may be located in a network, including the core network. A network node may communicate over a wired connection, over a wireless connection, or over both. A network node may include a processor and a communications interface. A network node may be or may include a network function (NF).

Generally, a communication system may use a combination of wired and wireless connections at different points in the system. One or more wireless technologies may (e.g., channel access methods), may include code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

A base station may be configured to transmit and/or receive wireless signals on one or more carrier frequencies, which may be referred to as a cell (not shown). A base station (201a, 201b) may communicate with one or more UEs (202a, 202b, 202c) over an air interface (211a, 211b, 211c, 211d).

In one case, one or more base stations may implement LTE radio access and NR radio access together, for instance using dual connectivity (DC) approach. Therefore, the system (e.g., and perhaps one or more UEs) may implement multiple types of radio access technologies that uses more than one type of base station (e.g., an eNB and a gNB).

In one case, the communication system may include a radio access network (RAN) 203, a core network (CN) 204, and one or more other elements represented by 205 (e.g., public switched telephone network (PSTN), the Internet, and other networks or the like).

In one scenario using FIG. 2 as an illustration, a RAN 203 may be in communication with a CN 204. The base station 201a may be an eNB, and the access technology may be based on E-UTRA (e.g., LTE, etc.). The communication system may handle data transmission from the UE 202a. The data may have varying quality of service (QoS) requirements, such as differing throughput requirements, latency requirements, error tolerance requirements, reliability requirements, data throughput requirements, mobility requirements, and the like. The CN 204 may provide call control, billing services, mobile location-based services, pre-paid calling, Internet connectivity, video distribution, etc., and/or perform high-level security functions, such as user authentication. Although not shown, the RAN 203 and/or the CN 204 may be in direct or indirect communication with other RANs that employ the same radio access technology (RAT) as the RAN 203 or a different RAT. For example, in addition to being connected to the RAN 203, which may be utilizing a NR radio access technology, the CN 204 may also be in communication with another RAN (not shown) employing another radio access technology (e.g., E-UTRA, WiFi, etc.). Each of the eNBs may be associated with a particular cell (not shown) and may be configured to handle radio resource management decisions, handover decisions, scheduling of users in the UL and/or DL, and the like. Each eNB may communicate with one another over an X2 interface (not shown).

In one scenario using FIG. 2 as an illustration, the RAN 203 and the CN 204 may employ NR radio access technologies and related protocols. The base station may be a gNB 201. The gNB(s) may implement carrier aggregation technology, where multiple component carriers may be transmitted to the UE 202a. A subset of these component carriers may be on unlicensed spectrum while the remaining component carriers may be on licensed spectrum. The UE(s) may communicate with the gNB(s) using transmissions associated with a scalable numerology (e.g., subcarrier spacing, etc.). For example, the OFDM symbol spacing and/or OFDM subcarrier spacing may vary for different transmissions, different cells, and/or different portions of the wireless transmission spectrum. The UE(s) may communicate with gNB(s) using subframe or transmission time intervals (TTIs) of various or scalable lengths (e.g., containing a varying number of OFDM symbols and/or lasting varying lengths of absolute time). The gNB(s) may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF), routing of control plane information towards Access and Mobility Management Function (AMF), and the like. The gNB(s) may communicate with one another over an Xn interface.

Not shown (e.g., but still possibly part of one or more example scenarios described herein), the CN may include one or more AMFs, one or more UPFs, one or more Session Management Functions (SMFs), and/or one or more Data Networks (DNS). In one case, the aforementioned elements may be owned and/or operated by an entity other than the CN operator.

In one scenario using FIG. 2 as an illustration, an Internet 205 may include a global system of interconnected computer networks and devices that use common communication protocols, such as the transmission control protocol (TCP), user datagram protocol (UDP) and/or the internet protocol (IP) in the TCP/IP internet protocol suite.

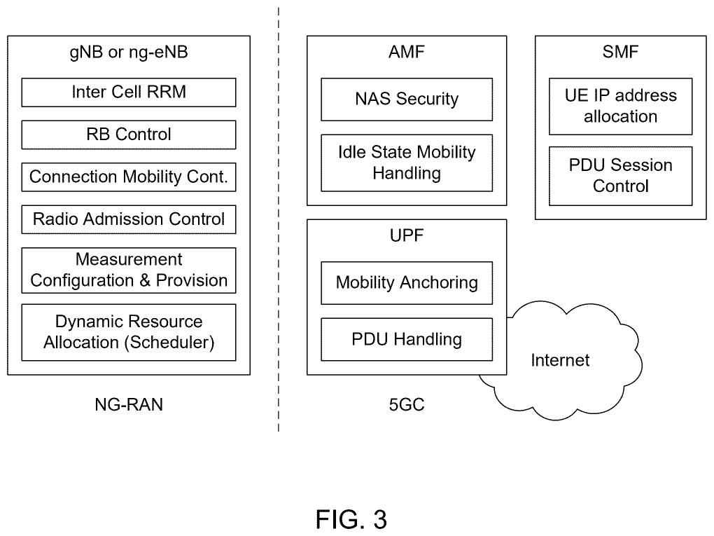

FIG. 3 illustrates an example of a functional split between the next generation radio access network (NG-RAN) and Fifth Generation (5G) core (5GC). The AMF may be connected to one or more gNB the RAN via an N2 interface and may serve as a control node. For example, the AMF may be responsible for authenticating a UE's support for network slicing (e.g., handling of different protocol data unit (PDU) sessions with different requirements), selecting a particular SMF, management of the registration area, termination of non-access stratum (NAS) signaling, mobility management, and the like. Network slicing may be used by the AMF in order to customize CN support for one or more UEs based on the types of services being utilized by the respective UE. For example, different network slices may be established for different use cases such as services relying on ultra-reliable low latency (URLLC) access, services relying on enhanced massive mobile broadband (eMBB) access, services for MTC access, and the like. The AMF may provide a control plane function for switching between the RAN and other RANs that employ other radio technologies (e.g., as described herein). The SMF may be connected to an AMF in the CN via an N11 interface. The SMF may also be connected to a UPF in the CN via an N4 interface. The SMF may select and control the UPF and configure the routing of traffic through the UPF. The SMF may perform other functions, such as managing and allocating UE IP address, managing PDU sessions, controlling policy enforcement and QoS, providing DL data notifications, and the like. A PDU session type may be IP-based, non-IP based, Ethernet-based, and the like. The UPF may be connected to one or more gNB in the RAN via an N3 interface, which may provide a UE with access to packet-switched networks, such as the Internet, to facilitate communications between one or more UEs and IP-enabled devices. The UPF may perform other functions, such as routing and forwarding packets, enforcing user plane policies, supporting multi-homed PDU sessions, handling user plane QoS, buffering DL packets, providing mobility anchoring, and the like. The CN may facilitate communications with other networks. For example, the CN may provide a UE with access to the other networks 212, which may include other wired and/or wireless networks that are owned and/or operated by other service providers. In one example, the UEs may be connected to a local DN through a UPF via an N3 interface to the UPF and an N6 interface between the UPF and the DN. As discussed herein, a NR RAN may be called an NG-RAN and a NR CN may be called a 5GC.

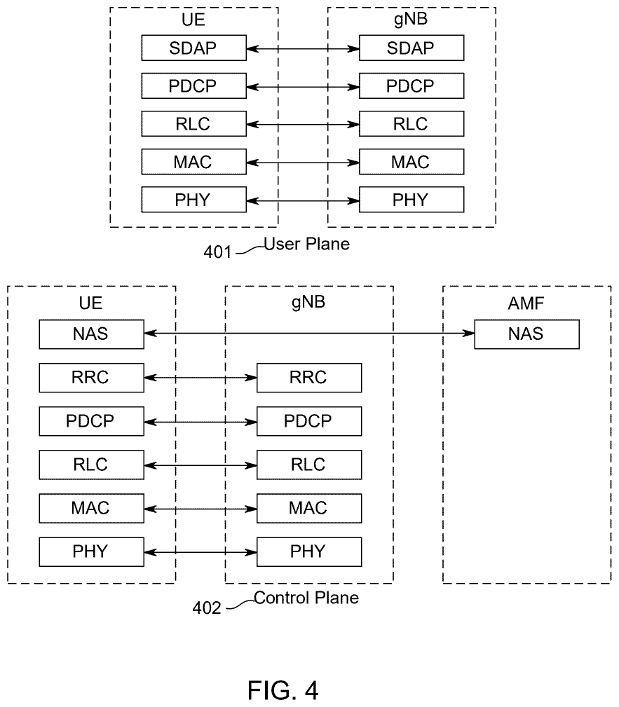

FIG. 4 illustrates an example of a protocol stack for the user plane and control plane. The user plane protocol stack 401 and the control plane stack 402. A higher layer may refer to one or more layers in a protocol stack, or a specific sublayer within the protocol stack. The protocol stack may comprise of one or more layers in a UE or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: NAS, Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

The examples provided herein are based on the Third Generation Partnership Project (3GPP) 5G architecture and the procedures associated with the 5GC. One with ordinary skills in the art may envision other technologies being used and the same concepts may apply. Examples of other technologies may be 4G, CBRS, cdma2000, 6G, and beyond. The examples provided herein should not limit the scope of the methods.

The 3GPP standards support the access to the 5GC via a wireline access network (AN). A wireline 5G access network (W-5GAN) is a wireline AN that may connect to a 5GC. For example, devices in a home local access network (LAN), such as a residential gateway (RG), may connect to the 5GC via a Wireline Access Gateway Function (W-AGF) in the W-5GAN. The W-AGF is a network function that may interface with the 5GC Control Plane (CP) and the 5GC User Plane (UP) functions, via N2 and N3 interfaces, respectively. In the example of a home LAN, the W-AGF may provide connectivity towards the 5GC to the home LAN devices using one or more N2 and N3 interfaces with the 5GC.

A residential gateway (RG) is a device providing, for example, voice, data, broadcast video, video on demand, etc. to other devices in specific locations referred to as customer premises. In this example, an RG may have one or more processors, such as Central Processing Units (CPUs), Graphical Process Units (GPUs), Front End Processors (FEPs), Communication Processors (CPs), Field Programmable Gate Arrays (FPGAs), Vision Processing Units (VPU), Quantum Processing Units (QPUs), Associative Processing Units (APUs), and Tensor Processing Units (TPUs); a baseband radio; one or more transceivers; one or more antennas; storage, such as HDD, SSD, NVM, RAM, ROM, memory, cache; memory controller(s), a touchscreen, and a power source. The RG may also have one or more of its functions virtualized.

An RG may contain functionality that enables devices behind it to also connect with the 5GC and obtain 5G services. The devices behind the RG may be of different types, such as 3GPP-capable devices (e.g., UEs), authenticable non-3GPP (AUN3) devices, non-authenticable non-3GPP (NAUN3) devices, or non-5G-Capable over WLAN (N5CW) devices. An RG may be 5G-capable, in which case it is referred to as a 5G-RG, or it may be non-3GPP capable, in which case it is referred to as a Fixed Network RG (FN-RG). The 5G-RG may play the role of a UE.

While reference to 5GC is mentioned to assist in explaining the concepts of the embodiments and examples provided herein, these embodiments and examples are equally applicable to other generations of wireless technologies, and may be interchangeable with 3G, 4G, 6G, etc.

There are benefits to both users and operators to allow RGs, and devices that are non-3GPP capable and are behind RGs, to access the 3GPP 5G 5GC. The 5GC provides several features that may be beneficial, independent of the type of access technology used by the devices accessing the network. Users may receive the benefits of the rich 5G features, and operators may have means to charge for the usage of such features.

As an example, there may be one or more procedures that enable access to the Evolved Packet Core (EPC) or the 5GC via non-3GPP RATs. One such example is a UE accessing the 5GC using WLAN.

Additionally, there may be one or more procedures for supporting access to the 5GC via a wireline AN. As an example, a home LAN may be connected to the 5GC via an RG. The RG may contain functionality that enables devices behind it to connect with the 5GC and obtain 5G services.

The 5G-RG and the W-AGF may interface with the 5GC Control Plane (CP) and the 5GC User Plane (UP) functions, via N2 and N3 interfaces, respectively. They may enable authentication, registration and packet data network (PDN) connectivity procedures associated with the devices behind the RG. They may facilitate the provisioning of differentiated services to the devices behind the RG, via the interfaces with the 5GC.

Between two operator networks, Security Edge Protection Proxies (SEPPs) negotiate security capabilities between themselves. A security capability negotiation over the N32-c interface allows the SEPPs to negotiate which security mechanism to use for protecting NF service-related signaling over the N32-f interface. There shall be an agreed security mechanism between a pair of SEPPs before conveying NF service-related signaling over the N32-f interface. A network node may be or may include an SEPP.

When an SEPP notices that it does not have an agreed security mechanism for N32-f interface protection with a peer SEPP or if the security capabilities of the SEPP have been updated, the SEPP shall perform security capability negotiation with the peer SEPP over the N32-c interface in order to determine, which security mechanism to use for protecting NF service-related signaling over the N32-f interface. Certificate based authentication shall follow the profiles previously given, such as in 3GPP TS 33.210 ,clause 6.2. The contents of 3GPP TS 33.210 are incorporated by reference herein as if fully set forth in their entirety.

A mutually authenticated transport layer security (TLS) connection as defined in clause 13.1 of 3GPP TS 33.501 or hypertext transfer protocol secure (HTTPS) and JWS as defined herein shall be used for protecting security capability negotiation over the N32-c interface in examples and embodiments provided herein. The contents of 3GPP TS 33.501 are incorporated by reference herein as if fully set forth in their entirety. The TLS connection shall provide integrity, confidentiality and replay protection.

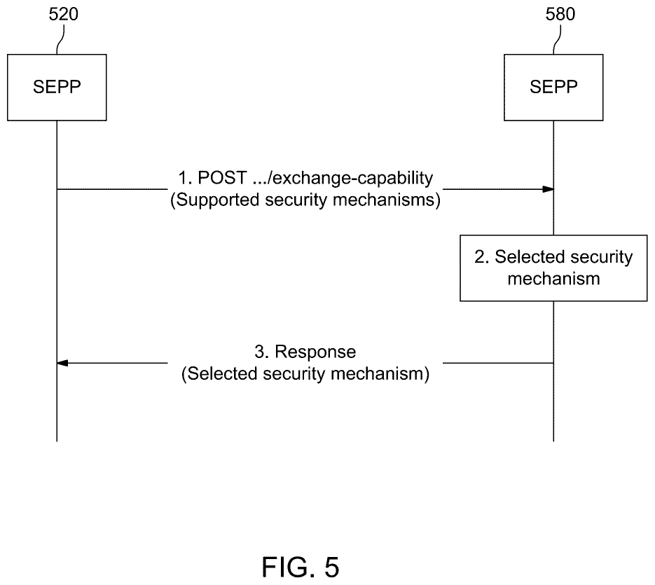

FIG. 5 illustrates an example of a security capability negotiation between Security Edge Protection Proxies (SEPPs). As shown in an example in the first step in FIG. 5, a SEPP 510, which initiated and completed the TLS connection establishment with a SEPP 580, shall issue a POST request to the exchange-capability resource of the responding SEPP 580 including the initiating SEPP's supported security mechanisms for protecting the NF service-related signaling over N32-f (see Table 1, below). The security mechanisms shall be ordered in the initiating SEPP's priority order.

In a second step, the responding SEPP 580 shall compare the received security capabilities to its own supported security capabilities and selects, based on its local policy (for example, based on whether there are roaming intermediary (RI) providers on the path between the SEPPs), a security mechanism, which is supported by both the initiating SEPP 520 and the responding SEPP 580. In a third step, the responding SEPP 580 shall respond to the initiating SEPP 520 with the selected security mechanism for protecting the NF service-related signaling over N32.

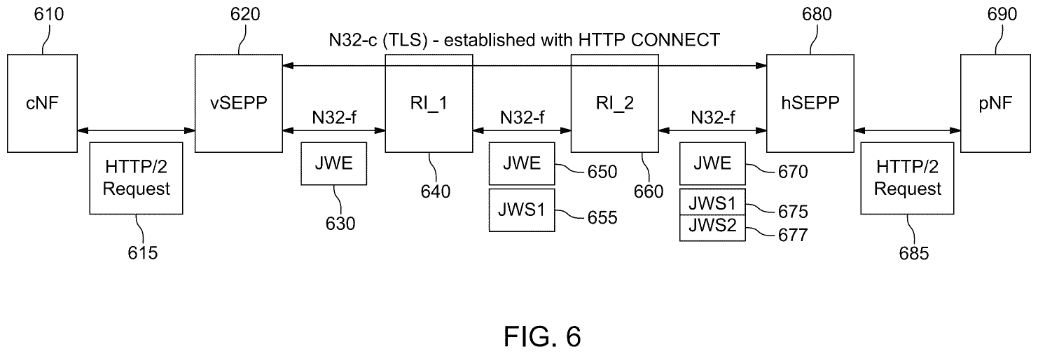

FIG. 6 is illustrates an example of the architecture for PRINS. In an example shown in FIG. 6, PRINS is used for end-to-end signaling security between a visited Security Edge Protection Proxy (SEPP) (vSEPP) 620 in a visited PLMN (vPLMN) and a home SEPP (hSEPP) 680 in a home PLMN (hPLMN). PRINS uses two different protocols for N32. The first protocol is end-to-end TLS for an N32-c connection. Specifically, PRINS uses HTTP CONNECT to establish the end-to-end TLS between vSEPP 620 and hSEPP 680.

The second protocol is end-to-end application layer security for an N32-f connection. The TLS security for the N32-f connection may use Internet Protocol Security (IPSec), TLS VPN, or both. Signaling messages are protected in the application layer with information elements protected with confidentiality, integrity based on policy, or both.

Within the end-to-end TLS tunnel between vSEPP and hSEPP, one or more of the following N32-c handshake procedures can be executed: the Security Capability Negotiation Procedure (including one or more of: the Parameter Exchange Procedure, the Cipher Suite Negotiation, the Protection Policy Exchange, and the Security Information List); the N32-f Termination Procedure; and the N32-f Error Reporting Procedure. These procedures may be executed as explained in 3GPP TS 29.573. The contents of 3GPP TS 29.573 are incorporated by reference herein as if fully set forth in their entirety. After N32-c procedures are completed, the N32-f interface can be initiated to forward NF signaling messages between the vSEPP 620 and hSEPP 680.

In an example shown in FIG. 6, a signaling message may originate in a consumer's NF (cNF) 610 and, accordingly, the cNF 610 may send an HTTP/2 request 615 to the vSEPP 620. In an example, vSEPP 620 may be a consumer's SEPP (cSEPP). Additionally or alternatively, the hSEPP 680 may be a producer's SEPP (pSEPP).

The N32-f/PRINS protects signaling messages in the application layer by reformulating an original HTTP/2 message into a JavaScript Object Notation (JSON) Web Encryption (JWE) token that is protected for integrity and confidentiality, for example, JWE tokens 630, 650, 670. Protection policies negotiated between the vSEPP 620 and hSEPP 680 (within an end-to-end TLS tunnel) dictates which information elements are protected for confidentiality, and which are modifiable by RIs, such as R1_1 640 and RI_2 660.

RIs can modify the protected JWE token by creating and appending a JSON patch that indicates the desired values of the modifiable information elements in the JWE token. A network node may be or may include an RI. For example, RI_1 640 may create JSON patch JWS1 655 and append it to JWE token 650. RI_2 660 may forward the JWE and patch as JWE 670 with JWS1 675, and further create and append JWS2 677, as shown in FIG. 6. Those JSON patches, when applied by a receiving SEPP, such as hSEPP 680, would result in a signaling message in the desired states of the RIs 640, 660. Further, hSEPP 680 may validate the JWE 670, JWS1 675 and JWS2 677, and check the modifications against its security policy. If all validations succeed, the pSEPP will recreate the HTTP/2 request message as HTTP/2 request 685. The hSEPP 680 sends the HTTP/2 request 685 to a producer's NF (pNF) 690. A receiving SEPP has a clear understanding of which entities on the signaling path has made what changes to the signaling message, achieving an important security property, namely attributability. Based on the protection policy, particularly the modification policy, a receiving SEPP can decide whether or not to accept a modification by an RI.

PRINS achieves an important objective of end-to-end security (between the vSEPP 620 and hSEPP 680) in the application layer for 5G roaming, while allowing authorized RIs 640, 660 to modify signaling messages as needed, albeit with additional complexity and overhead. PRINS was designed and specified based on the recommendations (application layer security) and requirements (mandatory to implement and use) provided to 3GPP by GSMA.

However, despite achieving this important objective, modifications to PRINS described herein will improve its security and efficiency for all system users. The modifications to PRINS described herein address several problems with the current PRINS N32-c interface, which is an end-to-end TLS tunnel between vSEPP and hSEPP.

This end-to-end TLS tunnel provides confidentiality, integrity, and anti-reply protection for N32-c handshake procedures. It can also export keying materials to be used by the symmetric crypto algorithms to protect N32-f/PRINS connection in the application layer.

However, this end-to-end TLS tunnel is problematic from the perspective of RIs in two aspects. First, it requires RIs to support HTTP CONNECT, which introduces both business and security risks to RIs. Second, the confidentiality protection of N32-c procedures appears to impede the operation of RIs.

Supporting HTTP CONNECT, without modification, includes risks. For example, by supporting HTTP CONNECT, RIs allow their HTTP proxies to become TCP proxies between vSEPP and hSEPP, potentially losing visibility and control of what are being transmitted through the TCP tunnel (e.g., when the tunnel is encrypted using TLS). Although legitimate SEPPs would only transmit N32-c handshake procedures within the end-to-end TLS tunnel, any web traffic such as N32-f signaling messages and non-web traffic such as mail traffic can be transmitted within the tunnel. N32-f signaling messages, if sent through the tunnel by untrusted SEPPs, prevent RIs from offing any value added services, resulting in business loss. No-web traffic such as email spams or malware, if transmitted through the tunnel by malicious parties, would result in security risks for the RIs.

Unfortunately, in current, unmodified PRINS, HTTP CONNECT requests are sent over TCP without any cryptographic authentication. Thus, not only a legitimate vSEPP and pSEPP, but any parties with access to the interconnection networks, are able to tunnel through RIs.

A recipient of HTTP CONNECT can only perform access control based on the IP address, which can be spoofed and requires substantial overhead in maintaining the allowed or disallowed IP list. Currently, 3GPP TS 29.573, section 5.5.2, specifies that HTTP CONNECT request shall include the following information in the 3gpp-Connect-Req-Infor header: Connect-purpose=“n32c”; Originating-network-id=vSEPP's PLMN-id; Sender-fqdn=vSEPP's fqdn or RI_1's fqdn; and Intended-n32-purpose=ROAMING). While a recipient may perform access control based on the content in the above header, its content is not cryptographically protected, thus can be spoofed, in current unmodified PRINS.

There appears no easy way for RIs to ensure that only N32-c handshake procedures are being transmitted within the tunnel, since RIs cannot inspect the encrypted tunnel. One mitigation is for RIs to impose a rate limit on the N32-c connection. This is possible, but would introduce configuration overhead for RIs. Even if rate limit on N32-c can be implemented by RIs, it only mitigates concerns on bandwidth usage, it does not provide any assurance that only N32-c procedures are being transmitted within the tunnel. Particularly, Ris cannot prove that their networks are not being misused, for example, to carry out malicious activities.

Without the modifications and example solutions provided herein, the best an RI can do to mitigate the misuse of HTTP CONNECT appears to be access control based on allowed list of IP addresses. This would once again introduce management overhead and impose deployment constraints, but without mitigating risks from misbehaving legitimate SEPPs.

Further, confidentiality protection of N32-c procedures is problematic to RIs since they need to know what are being negotiated between vSEPP and hSEPP to function properly. RIs needs to know what are being negotiated or exchanged between vSEPP and hSEPP.

Specifically, first, RIs need to know what security capability is being negotiated for N32-f to be able to apply their changes properly. Note that HTTP/2 messages sent over N32-f interface are of different formats for TLS and PRINS. If there would be more than one security mechanism between vSEPP and hSEPP, RIs would need to know which security mechanism is being selected. Thus, the confidentiality protection of security capability negotiation procedures is problematic for RIs considering the design objective of future-proofness of the procedure.

Second, the parameter exchange procedure for cipher suite for protecting N32-f/PRINS should also allow an RI to indicate the digitally signing algorithms it supports so that a commonly supported algorithm can be selected by the hSEPP. Otherwise, the hSEPP may not be able to validate an JSON patch created by an RI.

Third, the protection policies being exchanged between vSEPP and hSEPP should be made visible to RIs so they can be inspected and compared with the business contracts the RIs signed with the VPLMN and HPLMN. Otherwise, an RI has no confidence that the exchanged modification policies between vSEPP and hSEPP are correct, or its modifications will be accepted by the vSEPP and hSEPP. Examples provided herein provide solutions to these problems, including problems faced by the RIs.

To summarize, the confidentiality protection of N32-c, provided by the end-to-end TLS tunnel between vSEPP and hSEPP, appears problematic to RIs.

Several changes to PRINS are included in example solutions provided herein to address the above problems. One or more of the examples solutions provided herein apply to currently deployed communications systems, as well newly developed systems, such as Sixth Generation (6G) systems. In an example the changes to PRINS may be included in a new version of PRINS, which may be referred to as PRINS version 2 (PRINS v2). The changes to PRINS include one or a combination of the following.

PRINS v2 does not use HTTP CONNECT to establish an end-to-end TLS connection for N32-c interface. Rather, PRINS v2 uses HTTP scheme ‘https’ to establish TLS in hop-by-hop to protect the transport of N32-c procedures. This eliminates the business and security risks from supporting HTTP CONNECT for RIs.

Further, PRINS v2 uses JSON Web Signature (JWS) to protect the integrity of N32-c handshake procedures. In addition, PRINS v2 does not provide the end-to-end confidentiality of N32-c procedures so that RIs can inspect and participate in the N32-c procedures, e.g., to negotiate security mechanism and cipher suites with vSEPP and hSEPP as needed.

Without the end-to-end TLS for exporting keying materials for protecting N32-f/PRINS, PRINS v2 defines a new N32-c handshake procedure to establish shared keying materials between vSEPP and hSEPP.

PRINS v2 also uses HTTP scheme ‘https’ for protecting the transport of N32-f messages. This creates consistency between the transport protection of both N32-c and N32-f, eliminating ambiguities on certificate validation in N32-f/PRINS. Specifically, N32-c and N32-f can now share a common TLS tunnel that protects both N32-c procedures and N32-f signaling messages.

With those solutions, PRINS v2 harmonizes the operations of SEPPs and RIs for both N32-c and N32-f interfaces, improving its deployability for both operators and RIs. Further detail regarding those solutions is provided herein below.

Table 1 below includes NF service-related signaling traffic protection mechanisms over the N32 interface.

TABLE 1

| N32-f protection | |
|---|---|
| mechanism | Description |
| Mechanism 1 | PRINS |
| Mechanism 2 | TLS |
| Mechanism 3 | PRINS version 2 |
| Mechanism n | Reserved |

If the selected security mechanism is PRotocol for N32 INterconnect Security (PRINS), the SEPPs shall behave as specified in clause 13.2 of 3GPP TS 33.501. If the selected security mechanism is PRINS version 2.0, the SEPPs shall behave as described herein below. If the selected security mechanism is PRINS or PRINS version 2 (v2), the SEPP may indicate a security profile.

Further, a security profile can for example include pre-selected cipher suites, default modification policies and default data_type encryption policies and/or a list of information elements (IEs) to be protected, during the N32-c negotiation process.

As introduced above, PRINS v2, is based on PRINS but differs from PRINS in several aspects of N32-c connection.

In PRINS, N32-c is an end-to-end TLS connection between CSEPP and pSEPP over RIs, initiated by using HTTP CONNECT before establishing the TLS connection (for example, per 3GPP TS 29.573 section 5.5.2.1). PRINS v2 does not use HTTP CONNECT to establish end-to-end TLS connection for N32-c. Rather, PRINS v2 uses HTTPS and JWS to protect N32-c communication. In addition, PRINS v2 defines application layer authenticated key exchanges between CSEPP and pSEPP to derive shared keying materials for protecting N32-f communications between CSEPP and pSEPP using JSON Web Encryption (JWE), which may include using procedures as specified in RFC 7516. The contents of RFC 7516 are incorporated by reference herein as if fully set forth in their entirety. In this way, the N32-c is based on end-to-end application layer security in PRINS v2.

In this way, PRINS v2 uses hop-by-hop TLS (https) and application layer security (JWE and JWS) for protecting N32-c. Accordingly, the N32-c and N32-f are now fully consistent in terms of transport layer and application layer security. With those changes, PRINS v2 harmonizes the operations of SEPPs and roaming intermediaries for both N32-c and N32-f interfaces and to allow N32-c and N32-f to share a common TLS tunnel.

To summarize, in PRINS v2, the N32-c procedures are used between the SEPPs in two PLMNs for mutual authentication, security mechanism selection, key exchange, and negotiation of other security configuration parameters. N32-c procedures shall use HTTPS for transport layer protection and JWS/JWE for application layer protection.

The first N32-c procedure to be executed between the SEPPs in two PLMNs shall be the security capability negotiation procedure, further explained below. If the negotiated security protection mechanism is PRINS v2, the key exchange procedure (further explained below) shall be executed next in order to establish the shared keying materials between the two SEPPs for protecting subsequent communication, including other N32-c procedures and the N32-f interface.

In an example, the key exchange procedure can be combined with the security capability negotiation procedure. For example, an initiating SEPP supporting both PRINS and PRINS v2 can include the key exchange IEs in the security capability negotiation request, and the receiving SEPP supporting PRINS v2 can include the key exchange IEs into the security capability negotiation response. A receiving SEPP supporting only PRINS will ignore the key exchange IEs which it cannot interpret.

The security capability negotiation procedure as defined in 3GPP TS 33.501 section 13.5 and 3GPP TS 29.573 section 5.2.2 applies. In addition, the security capability negotiation request and response shall be protected with JWS. A roaming intermediary can decide whether to allow a security capability negotiation based on the authenticated PLMN IDs either in the TLS certificate or JWS protected request message. A roaming intermediary, if allowing the N32-c connection, shall include its own authenticated identity as a JWS token in the security capability negotiation request. A receiving SEPP can additionally use the authenticated roaming intermediary identities in the security capability negotiation request to decide whether to continue the N32-c negotiation. The receiving SEPP shall include all roaming intermediaries in the security capability negotiation response message. The initiating SEPP can also additionally use the roaming intermediary information in the response message to decide whether to continue N32-c negotiation.

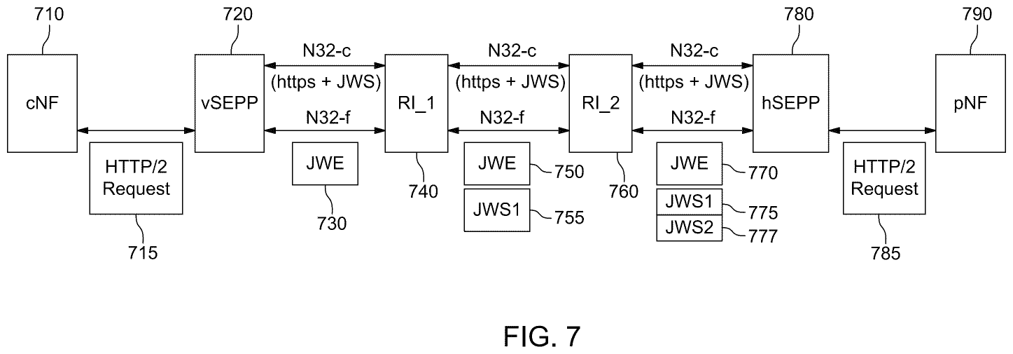

FIG. 7 illustrates an example of the architecture for PRINS v2 with N32-c establishment. In an example shown in FIG. 7, PRINS v2 is used for end-to-end signaling security between a vSEPP 720 in a vPLMN and a hSEPP 780 in an hPLMN. PRINS v2 uses two interfaces (N32-c and N32-f), which are logically separate but can share a common TLS tunnel.

The first protocol is an N32-c connection among the vSEPP 720, the hSEPP 780 and intervening nodes, established hop-by-hop. Specifically, PRINS v2 uses a first HTTPS message appended with a first JWS to establish a first N32-c connection between vSEPP 720 and an RI_1 740. Likewise, PRINS v2 uses a second HTTPS message appended with a second JWS to establish a second N32-c connection between the RI_1 740 and an RI_2 760. Similarly, PRINS v2 uses a third HTTPS message appended with a third JWS to establish a third N32-c connection between the RI_2 760 and the hSEPP 780. In this way, PRINS v2 protects the transport of N32-c communication using TLS hop-by-hop, which can also be used to transport N32-f signaling messages.

The second protocol is end-to-end application layer security for an N32-f connection. Similarly to the examples shown in FIG. 6 above, in examples in FIG. 7, the TLS security for the N32-f connection may use IPsec, TLS VPN, or both. Signaling messages are protected in the application layer with information elements protected with confidentiality, integrity based on policy, or both.

After N32-c procedures are completed, the N32-f interface can be initiated or the N32-c interface is reused to forward NF signaling messages between the vSEPP 720 and hSEPP 780.

In an example shown in FIG. 7, a signaling message may originate in a consumer's NF (cNF) 710 and, accordingly, the cNF 710 may send an HTTP/2 request 715 to the vSEPP 720. In an example, vSEPP 720 may be a consumer's SEPP (cSEPP). Additionally or alternatively, the hSEPP 780 may be a producer's SEPP (pSEPP).

The N32-f/PRINS protects signaling messages in the application layer by reformulating an original HTTP/2 message into a JavaScript Object Notation (JSON) Web Encryption (JWE) token that is protected for integrity and confidentiality, for example, JWE tokens 730, 750, 770. Protection policies negotiated between the vSEPP 720 and hSEPP 780 dictates which information elements are protected for confidentiality, and which are modifiable by RIs, such as the R1_1 740 and RI_2 760.

RIs can modify the protected JWE token by creating and appending a JSON patch that indicates the desired values of the modifiable information elements in the JWE token. A network node may be or may include an RI. For example, RI_1 740 may create JSON patch JWS1 755 and append it to JWE token 750. RI_2 760 may forward the JWE and patch as JWE 770 with JWS1 775, and further create and append JWS2 777, as shown in FIG. 7. Those JSON patches, when applied by a receiving SEPP, such as hSEPP 780, would result in a signaling message in the desired states of the RIs 740, 760. Further, hSEPP 780 may validate the JWE 770, JWS1 775 and JWS2 777, and check the modifications against its security policy. If all validations succeed, the pSEPP will recreate the HTTP/2 request message as HTTP/2 request 785. The hSEPP 780 sends the HTTP/2 request 785 to a producer's NF (pNF) 790. A receiving SEPP has a clear understanding of which entities on the signaling path has made what changes to the signaling message, achieving an important security property, namely attributability. Based on the protection policy, particularly the modification policy, a receiving SEPP can decide whether or not to accept a modification by an RI. In this way, PRINS v2 eliminates the business and security risks from supporting HTTP CONNECT for RIs 740, 760.

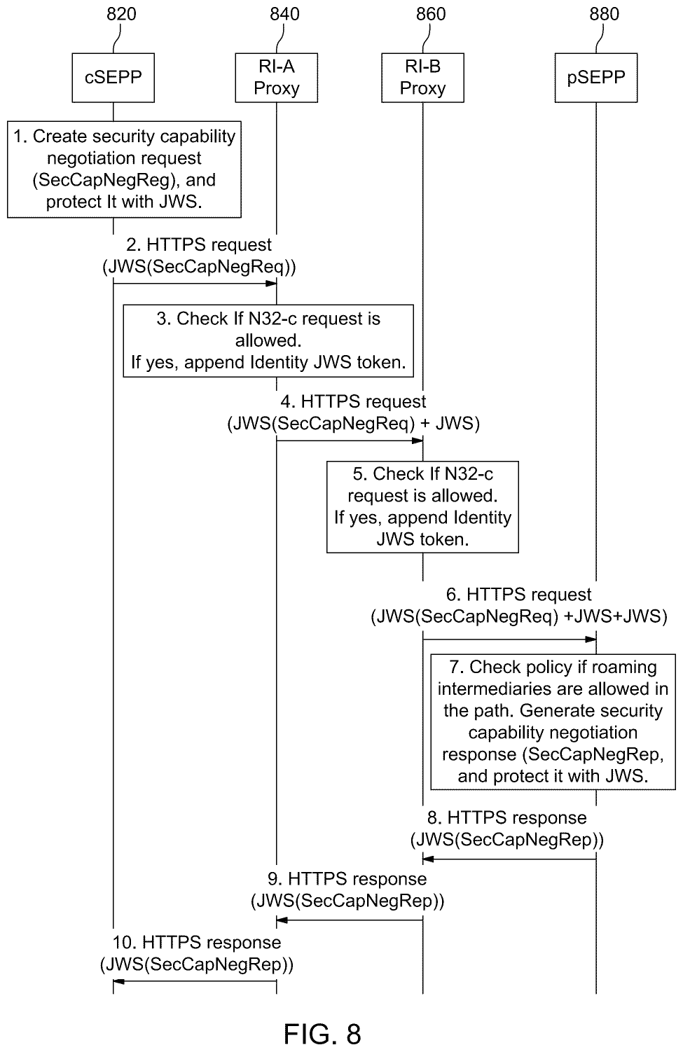

FIG. 8 illustrates an example of a PRINSv2 security capability negotiation procedure. As shown in a first step in an example in FIG. 8, a cSEPP 820 shall use HTTPS as the URI scheme and establish a TLS connection with the RI-A Proxy 840. The CSEPP 820 should include the fully qualified domain name (FQDN) of the RI-A in the security capability negotiation request message. The CSEPP 820 shall protect all IEs in the security capability negotiation request message with JWS using digital signature. The CSEPP's public key certificate shall be included in the JWS token. In this way, the cSEPP 820 creates a security capability negotiation request (SecCapNegReq), and protects it with JWS.

In a second step, the cSEPP 820 shall send the JWS protected security negotiation request message to the RI-A 840 over TLS. In this way, the cSEPP 820 sends the HTTPS request (JWS (SecCapNegReq)) to the RI-A 840.

In a third step, the RI-A 840 checks the security negotiation request message against its security and contractual policies to decide whether to allow this N32 connection negotiation. If it is allowed, the RI-A 840 shall include, or append, the cSEPP PLMN ID and FQDNs of its own and an RI-B Proxy 860 (in order of CSEPP-RI-A-RI-B) as a JWS token in the security negotiation request message.

In a fourth step, the RI-A 840 shall send the JWS protected security negotiation request message to the RI-B 860 over TLS. In this way, the RI-A 840 sends the HTTPS request (JWS (SecCapNegReq)) to the RI-B 860.

In a fifth step, the RI-B 860 checks the security negotiation request message against its security and contractual policies to decide whether to allow this N32 connection negotiation. If it is allowed, the RI-B 860 shall include, or append, the FQDNs of the RI-A 840 and its own and the pSEPP ID (in the order of RI-A-RI-B-pSEPP) as a JWS token in the security negotiation request message.

In a sixth step, the RI-B 860 shall send the JWS protected security negotiation request message to a pSEPP 880 over TLS. In this way, the RI-B 860 sends the HTTPS request (JWS (SecCapNegReq)) to the pSEPP 880.

In a seventh step, the pSEPP 880 shall construct the roaming path (cSEPP-RI-A-RI-B-pSEPP) based on the JWS tokens in the security negotiation request message. The pSEPP 880 can use the roaming path information in deciding whether to accept the security negotiation request message. Accordingly, the pSEPP 880 checks the security negotiation request message against its policy. If accepted, the pSEPP 880 shall include the roaming path information in the security negotiation response message. In this way, the pSEPP 880 generates a security negotiation response (SecCapNegRep). The pSEPP 880 shall protect all IEs in the security capability negotiation response message with JWS using digital signature. The pSEPP's public key certificate shall be included in the JWS token.

In an eighth step, the pSEPP 880 shall send the JWS protected security negotiation response message to the RI-B 860 over TLS. In this way, the pSEPP 880 sends an HTTPS response (JWS (SecCapNegRep)) to the RI-B 860.

In a ninth step, the RI-B 860 shall send the JWS protected security negotiation response message to the RI-A 840 over TLS. In this way, the RI-B 860 sends the HTTPS response (JWS (SecCapNegRep)) to the RI-A 840. Additionally or alternatively, the RI-B 860 sends a fifth JWS token to the RI-A 840. The fifth JWS token may protect one or more information elements that the RI-B 860 may add to the HTTPS response.

In a tenth step, the RI-A 840 shall send the JWS protected security negotiation response message to the cSEPP 820 over TLS. In this way, the RI-A 840 sends the HTTPS response (JWS (SecCapNegRep)) to the cSEPP 820. Additionally or alternatively, the RI-A 840 sends the fifth JWS token to the cSEPP 820. Additionally or alternatively, the RI-A 840 sends a sixth JWS token to the cSEPP 820. Additionally or alternatively, the sixth JWS token may protect one or more information elements that the RI-A 840 may add to the HTTPS response. The CSEPP 820 can use the roaming path information in the security negotiation response message in deciding whether to continue the N32-c negotiation.

In an example, a first network node establishes a transport layer security (TLS) connection with a second network node. The TLS connection is established using hypertext transfer protocol secure (HTTPS) as a uniform resource identifier (URI).

The first network node creates a security negotiation request message, including a fully qualified domain name (FQDN) of the second network node. Further, the first network node protects one or more information elements (IEs) in the security negotiation request message with a first JavaScript Object Notation (JSON) Web Signature (JWS) token. The first JWS token uses a first digital signature and includes a public key certificate of the first network node. Moreover, the first network node sends over TLS, to the second network node, a first HTTPS request, including the security negotiation request message and the first JWS token.

Additionally or alternatively, the second network node receives receive, from the first network node, the first HTTPS request, including the security negotiation request message and the first JWS token. Further, the second network node determines to allow an N32 connection negotiation based on checking the security negotiation request message against the security and contractual policies of the second network node. Also, the second network node appends, based on the determination to allow the N32 connection negotiation, a public land mobile network (PLMN) identity (ID) of the first network node, an FQDN of the second network node, and an FQDN of a third network node as a second JWS token to the security negotiation request message. Moreover, the second network node sends over TLS, to the third network node, a second HTTPS request, including the security negotiation request message, the first JWS token and the second JWS token.

Additionally or alternatively, the third network node receives from the second network node, the second HTTPS request, including the security negotiation request message, the first JWS token and the second JWS token. The third network node determines to allow an N32 connection negotiation based on checking the security negotiation request message against the security and contractual policies of the third network node. Further, the third network node appends, based on the determination to allow the N32 connection negotiation, an FQDN of the second network node, the FQDN of the third network node, and a PLMN ID of a fourth network node, as a third JWS token to the security negotiation request message. Moreover, the third network node sends over TLS, to the fourth network node, a third HTTPS request, including the security negotiation request message, the first JWS token, the second JWS token and the third JWS token.

Additionally or alternatively, the fourth network node receives, from the third network node, the third HTTPS request, including the security negotiation request message the first JWS token, the second JWS token and the third JWS token. The fourth network node constructs a roaming path based on the first JWS token, the second JWS token, and the third JWS token. The roaming path is a path from the first network node to the second network node, then to the third network node and ending at the fourth network node. Further, the fourth network node accepts the security negotiation request message based on roaming path information corresponding to the roaming path. Also, the fourth network node generates a security negotiation response message. In addition, the fourth network node includes, based on the determination to accept the security negotiation request message, the roaming path information in the security negotiation response message. Further, the fourth network node protects one or more IEs in the security negotiation response message with a fourth JWS token. The fourth JWS token uses a second digital signature and includes a public key certificate of the fourth network node. Moreover, the fourth network node sends over TLS, to the third network node, a first HTTPS response, including the security negotiation response message and the fourth JWS token.

Additionally or alternatively, the third network node receives, from the fourth network node, the first HTTPS response, including the security negotiation response message and the fourth JWS token. Further, the third network node sends over TLS, to the second network node, a second HTTPS response, including the security negotiation response message, the fourth JWS token and a fifth JWS token.

Additionally or alternatively, the second network node receives, from the third network node, the second HTTPS response, including the security negotiation response message, the fourth JWS token and the fifth JWS token. Further, the second network node sends over TLS, to the first network node, a third HTTPS response, including the security negotiation response message, the fourth JWS token, the fifth JWS token, and a sixth JWS token.

Additionally or alternatively, the first network node is a consumer's Security Edge Protection Proxy (SEPP) (CSEPP), the second network node is a first RI Proxy, the third network node is a second RI Proxy, and the fourth network node is a producer's SEPP (pSEPP). Additionally or alternatively, the first network node is a visited PLMN SEPP (vSEPP), and the second network node is a home SEPP (hSEPP).

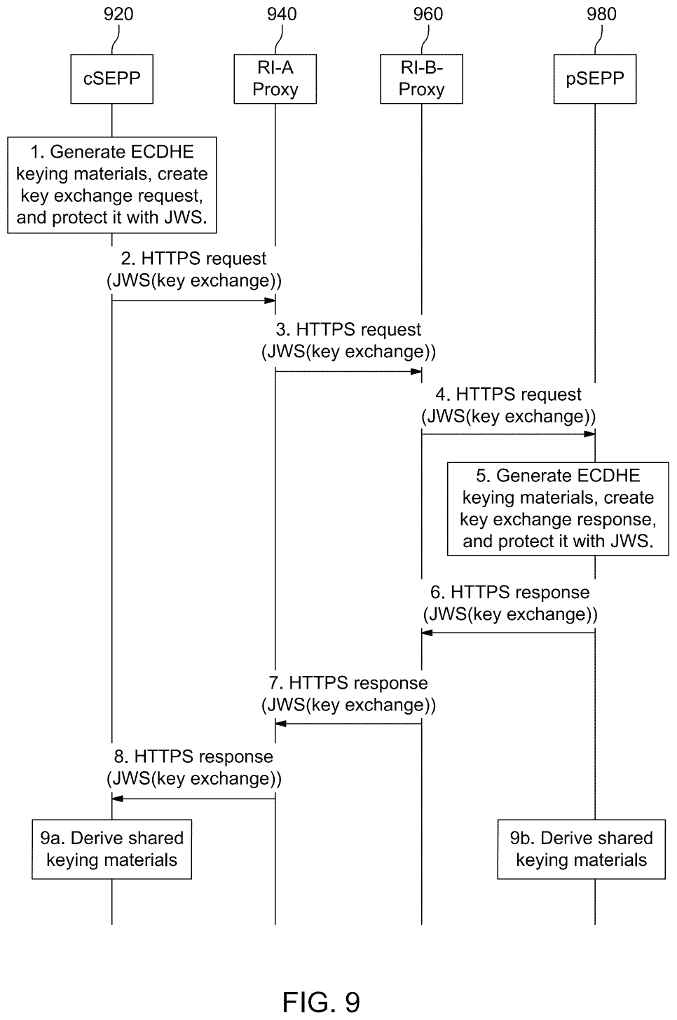

FIG. 9 illustrates an example of a key exchange procedure initiated by a cSEPP. If the negotiated security protection mechanism is PRINS v2 and the key exchange IEs are not included in the security capability negotiation request or response message, a CSEPP 920 shall initiate this key exchange procedure, including one or more steps in the following.

In a first step, the cSEPP 920 shall generate its Elliptic Curve Diffie-Hellman Key Exchange (ECDHE) keying materials. In an example, the keying materials may be generated as explained in section 6 of RFC 7748. The contents of RFC 7748 are incorporated by reference herein as if fully set forth in their entirety. Further, the cSEPP 920 shall create a key exchange request. The cSEPP 920 shall protect all IEs (including the ECDHE groups and its ECDHE public values) in the key exchange request message with JWS using digital signature.

In a second step, the cSEPP 920 shall send the JWS protected key exchange request message to an RI-A Proxy 940 over TLS. In this way, the cSEPP 920 sends the HTTPS request (JWS (key exchange)) to the RI-A 940.

In a third step, the RI-A 940 shall send the JWS protected key exchange request message to the RI-B Proxy 960 over TLS. In this way, the RI-A 940 sends the HTTPS request (JWS (key exchange)) to the RI-B 960.

In a fourth step, the RI-B 960 shall send the JWS protected key exchange request message to a pSEPP 980 over TLS. In this way, the RI-B 960 sends the HTTPS request (JWS (key exchange)) to the a pSEPP 980.

In a fifth step, the pSEPP 980 shall generate its ECDHE keying materials. In an example, the keying materials may be generated as explained in section 6 of RFC 7748. Further, the pSEPP 980 shall create a key exchange response. The pSEPP 980 shall protect all IEs (including the selected ECDHE group and its ECDHE public value) in the key exchange response message with JWS using digital signature.

In a sixth step, the pSEPP 980 shall send the JWS protected key exchange response message to an RI-B Proxy 960 over TLS. In this way, the pSEPP 980 sends the HTTPS response (JWS (key exchange)) to the RI-B Proxy 960.

In a seventh step, the RI-B 960 shall send the JWS protected key exchange response message to the RI-A Proxy 940 over TLS. In this way, the RI-B 960 sends the HTTPS response (JWS (key exchange)) to the RI-A Proxy 940.

In an eighth step, the RI-A 940 shall send the JWS protected key exchange response message to the cSEPP 920 over TLS. In this way, the RI-A 940 sends the HTTPS response (JWS (key exchange)) to the cSEPP 920.

After the cSEPP receives the key exchange response in the eighth step, the CSEPP sends back an authentication confirmation message back to pSEPP via RI-A and RI-B. For simplicity, this step is not shown in FIG. 9.

In a ninth step, shown in FIG. 9 as steps 9a and 9b, the cSEPP 920 and pSEPP 980 calculate the shared secret respectively. In an example, the shared secret is calculated as explained in section 5 of RFC 7748. Additionally or alternatively, the calculated shared secret may be used as the N32-f master key. Additionally or alternatively, the calculated shared secret need further derivation before being used as the N32-f master key.

In another example, a first network node generates Elliptic Curve Diffie-Hellman Key Exchange (ECDHE) keying materials for the first network node, including one or more first information elements for one or more ECDHE groups, and one or more second information elements for one or more ECDHE public values of the first network node. The first network node protects the one or more first information elements and one or more second information elements with a first JavaScript Object Notation (JSON) Web Signature (JWS) token. The first JWS token uses a first digital signature. Further, the first network node includes the one or more first information elements and one or more second information elements in a key exchange request message. Moreover, the first network node sends over transport layer security (TLS), to a second network node, a first HTTPS request, including the key exchange request message and the first JWS token.

Additionally or alternatively, the second network node receives, from the first network node, the first HTTPS request, including the key exchange request message and the first JWS token. The second network node sends over TLS, to a third network node, a second HTTPS request, including the key exchange request message and the first JWS token.

The third network node receives, from the second network node, the second HTTPS request, including the key exchange request message and the first JWS token. The network node sends over TLS, to a fourth network node, a third HTTPS request, including the key exchange request message and the first JWS token.

Additionally or alternatively, the fourth network node receives, from the third network node, the third HTTPS request, including the key exchange request message and the first JWS token. The fourth network node generates ECDHE keying materials for the fourth network node, including one or more third information elements for one or more selected ECDHE groups, and one or more fourth information elements for one or more ECDHE public values of the fourth network node. Further, the fourth network node protects the one or more third information elements and one or more fourth information elements with a second JWS token. The second JWS token uses a second digital signature. Also, the fourth network node includes the one or more third information elements and one or more fourth information elements in a key exchange response message. In addition, the fourth network node sends over TLS, to the third network node, a first HTTPS response, including the key exchange response message and the second JWS token. Moreover, the fourth network node derives shared keying materials, including a shared secret, based on the one or more first information elements, the one or more second information elements, the one or more third information elements, and the one or more fourth information elements.

Additionally or alternatively, the third network node receives, from the fourth network node, the first HTTPS response, including the key exchange response message and the second JWS token. The third network node sends over TLS, to the second network node, a second HTTPS response, including the key exchange response message and the second JWS token.

The second network node receives, from the third network node, the second HTTPS response, including the key exchange response message and the second JWS token. Moreover, the second network node sends over TLS, to the first network node, a third HTTPS response, including the key exchange response message and the second JWS token.

Additionally or alternatively, the first network node receives, from the second network node, the third HTTPS response, including the key exchange response message and the second JWS token. Further, the first network node sends, to the fourth network node via the second network node and the third network node, an authentication confirmation message. The first network node derives the shared keying materials, including the shared secret, based on the one or more first information elements, the one or more second information elements, the one or more third information elements, and the one or more fourth information elements. Moreover, the fourth network node receives, from the first network node via the second network node and the third network node, the authentication confirmation message.

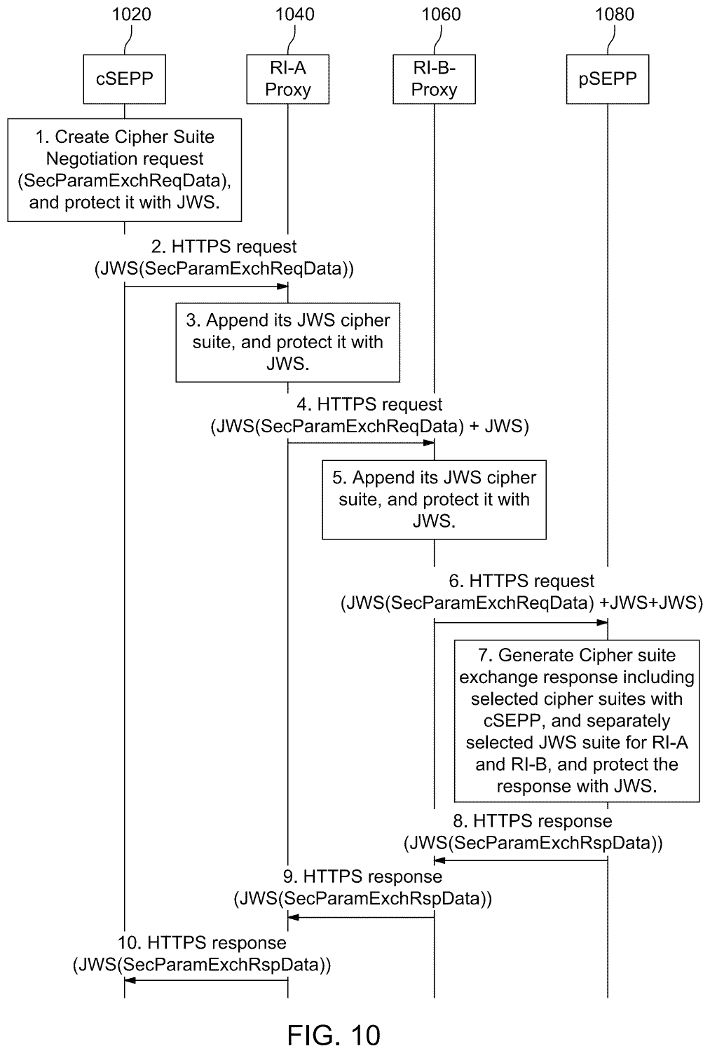

FIG. 10 illustrates an example of a cipher suite exchange procedure. In a first step in an example shown in FIG. 10, a cSEPP 1020 creates a cipher suit negotiation request, including a SecParamExchReqData parameter, and protects the request with JWS using digital signature.

In a second step, the cSEPP 1020 sends the JWS protected SecParamExchReqData in an HTTPS request to an RI-A proxy 1040. In a third step, the RI-A 1040 appends its JWS cipher suite to the JWS protected SecParamExchReqData, and protects it with a further JWS using digital signature. In a fourth step, the RI-A 1040 sends the JWS protected SecParamExchReqData, further protected by the JWS cipher suite of RI-A 1040, in an HTTPS request to an RI-B Proxy 1060.

In a fifth step, the RI-B 1060 appends its JWS cipher suite to the JWS protected SecParamExchReqData, with protection by the JWS cipher suite of RI-A 1040. In a sixth step, the RI-B 1060 sends the JWS protected SecParamExchReqData, further protected by the JWS cipher suite of RI-A 1040 and the JWS cipher suite of RI-B 1060, in an HTTPS request to a pSEPP 1080.

In a seventh step, the pSEPP 1080 generates a Cipher suit exchange response, including selected cipher suites with cSEPP 1020, and separately selected JWS suite for RI-A 1040 and RI-B 1060. Further the pSEPP 1080 protects the response with JWS using digital signature. The response may be or may include SecParamExchRspData.

In an eighth step, the pSEPP 1080 the JWS protected SecParamExchRspData in an HTTPS response to the RI-B 1060. Further, the RI-B 1060 sends the JWS protected SecParamExchRspData in an HTTPS response to the RI-A 1040, in a ninth step. Moreover, the RI-A 1040 sends the JWS protected SecParam ExchRspData in an HTTPS response to the cSEPP 1020, in a tenth step.

Additionally or alternatively, subsequent N32-c procedures shall be protected with JWS. Additionally or alternatively, subsequent N32-c procedures shall be protected with HTTPS.

In another example, a first network node creates a cipher suite negotiation request message. The first network node protects the cipher suite negotiation request message with a first JavaScript Object Notation (JSON) Web Signature (JWS) token. Further, the first network node sends, to a second network node, a first HTTPS request, including the cipher suite negotiation request message and the first JWS token.

Additionally or alternatively, the second network node receives. The second network node appends a JWS cipher suit of the second network node to the cipher suite negotiation request message. Further, the second network node protects the JWS cipher suit of the second network node with a second JWS token. Also, the second network node sends, to a third network node, a second HTTPS request, including the cipher suite negotiation request message, the first JWS token and the second JWS token.

Additionally or alternatively, the third network node receives, from the second network node, the second HTTPS request, including the cipher suite negotiation request message, the first JWS token and the second JWS token. The third network node appends a JWS cipher suit of the third network node to the cipher suite negotiation request message. Further, the third network node protects the JWS cipher suit of the third network node with a third JWS token. Moreover, the third network node sends, to a fourth network node, a third HTTPS request, including the cipher suite negotiation request message, the first JWS token, the second JWS token and the third JWS token.

Additionally or alternatively, the fourth network node receives, from the third network node, the third HTTPS request, including the cipher suite negotiation request message, the first JWS token, the second JWS token and the third JWS token. Further, the fourth network node generates a cipher suite exchange response message, including one or more selected cipher suites with the first network node, a separately selected JWS suite for the second network node and the third network node. Also, the fourth network node protects the cipher suite exchange response message with a fourth JWS token. Moreover, the fourth network node sends, to a third network node, a first HTTPS response, including the cipher suite exchange response message and the fourth JWS token.

Additionally or alternatively, the third network node receives, from the fourth network node, the first HTTPS response, including the cipher suite exchange response message and the fourth JWS token. Further, the third network node sends, to the second network node, a second HTTPS response, including the cipher suite exchange response message and the fourth JWS token.

Additionally or alternatively, the second network node receives, from the third network node, the second HTTPS response, including the cipher suite exchange response message and the fourth JWS token. Moreover, the second network node sends, to the first network node, a third HTTPS response, including the cipher suite exchange response message and the fourth JWS token.

Additionally or alternatively, the first network node is a consumer's Security Edge Protection Proxy (SEPP) (cSEPP), the second network node is a first RI Proxy, the third network node is a second RI Proxy, and the fourth network node is a producer's SEPP (pSEPP). Additionally or alternatively, the first network node is a visited PLMN SEPP (vSEPP), and the second network node is a home SEPP (hSEPP).

In environments, with HTTP proxies that terminate TCP connections (common in content distribution networks, enterprise networks, 5G, and emerging 6G architectures), a TLS session will normally terminate at the proxy unless special tunneling methods (e.g., the HTTP CONNECT method) are used. However, many proxies do not permit CONNECT due to security and business concerns: allowing end-to-end TCP tunnels would blind the proxy to the traffic content (which could be malicious) and undermine value-added services like content filtering. For example, in 5G core networks (with an indirect communication model), use of CONNECT is explicitly disallowed. As a result, standard end-to-end TLS is often blocked or terminated by such proxies.

Accordingly, embodiments and examples provided in the following herein define methods to perform end-to-end TLS handshake key agreements by encapsulating TLS messages within HTTP requests and responses. By transporting the TLS handshake over HTTP, a client and server can negotiate cryptographic keys across HTTP-only proxies that do not support direct TLS or CONNECT tunneling. The established TLS keys are then exported to the application layer for end-to-end encryption of sensitive data (for example, using JSON Web Encryption (JWE) or JSON Web Signature (JWS)). This approach enables secure communication in proxy-restricted environments without requiring changes to the proxies.

Encapsulating TLS inside HTTP does introduce technical trade-offs and implications. There is additional protocol overhead (each TLS handshake flight becomes an HTTP message) and increased handshake latency due to HTTP request/response cycles. The approach shifts the responsibility of data encryption to the application layer using the exported keys, rather than relying on a continuous TLS transport session. This allows finer control (e.g., encrypting only certain fields with JWE) at the cost of complexity in application logic and potential performance overhead. Despite these trade-offs, the method leverages the proven security of TLS even when a direct TLS transport is not available, which is particularly valuable in scenarios where proxy policies or network architectures (such as in future 6G networks) would otherwise prevent secure end-to-end channels.

Embodiments and examples provided in the following herein use the following terms. A client is an entity initiating the TLS handshake over HTTP (e.g. a browser or mobile app). A server is an entity responding to the TLS handshake encapsulated in HTTP (e.g., a web server or service endpoint). A proxy is an intermediary that forwards HTTP messages between the client and the server without TLS tunneling. A proxy may be or may include one or more proxy servers. An encapsulated TLS handshake is a standard TLS handshake whose messages are transported within HTTP request and response bodies instead of over a direct TCP/TLS connection.

An overview of a protocol example is provided in the following. In an example, the TLS handshake follows the standard TLS 1.3 exchange, but the handshake messages are wrapped inside HTTP POST requests and HTTP responses. The client and server use HTTP as a carrier for the TLS handshake messages, and upon completion of the handshake, both parties obtain shared keying material that can be used by the application. Importantly, the TLS messages themselves are not altered-they are simply conveyed as HTTP payload—so they include the usual TLS handshake structures (ClientHello, ServerHello, Certificates, Finished messages, etc.) and semantics (e.g. version negotiation, cipher suites, key exchange) as defined in TLS 1.3 (RFC 8446). The contents of RFC 8446 are incorporated by reference herein as if fully set forth in their entirety.

From the perspective of TLS, the handshake proceeds as normal, but the transport for the handshake is an HTTP conversation rather than a raw TCP stream. This means the client and server must maintain a TLS handshake state across multiple HTTP message exchanges. In particular, each flight of TLS handshake messages is encapsulated in an HTTP request or response, as illustrated below.

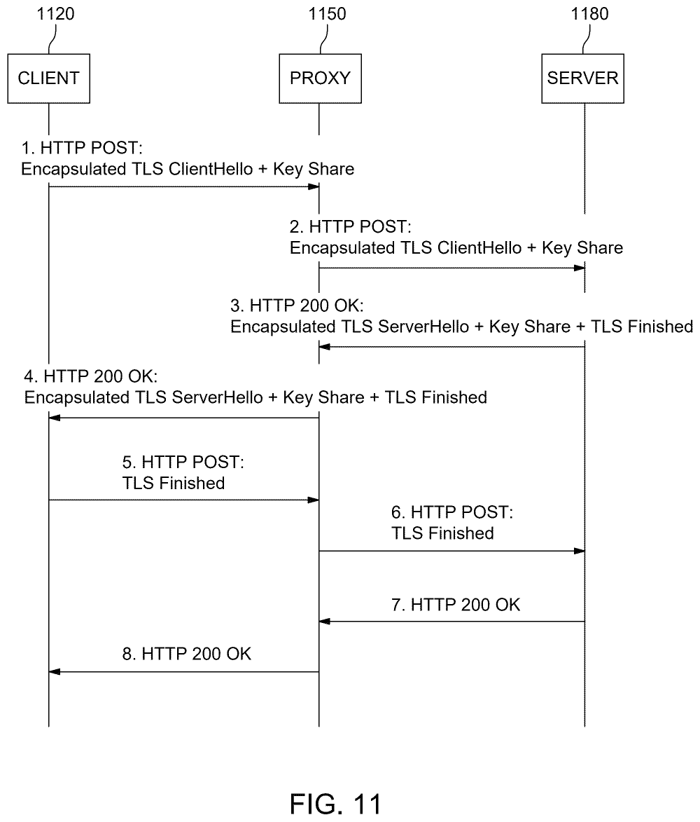

FIG. 11 is an example message flow of a transport layer security (TLS) handshake over hypertext transfer protocol (HTTP). As shown in a first step in an example in FIG. 11, a client 1120 sends a TLS ClientHello message including a client key_share for Diffie-Hellman, as the body of an HTTP POST request (to a known endpoint on the server, e.g./tls-handshake). The Content-Type is set to application/tls-handshake to indicate the payload is a TLS handshake message. The HTTP request (and all following requests in this sequence) can be sent over an existing HTTP/1.1 or HTTP/2 connection to the proxy 1150 (or directly to the server if no proxy is in path). The proxy 1150 forwards the request to an HTTP endpoint in server 1180, in a second step.

In a third step, a ServerHello message, and Server Handshake related messages, are sent. Specifically, the server 1180, upon receiving the ClientHello in an HTTP request, processes the TLS handshake message. The server 1180 then responds with an HTTP 200 OK status message carrying the TLS ServerHello message in the response body (also using content type application/tls-handshake). The HTTP 200 OK status message may be received by the proxy 1150. In a full TLS 1.3 handshake, this server HTTP response would typically include the ServerHello, the server's certificate (if using TLS with certificates), a server key_share for Diffie-Hellman, and optionally other handshake messages (e.g., CertificateRequest). These TLS messages are concatenated in the HTTP response payload. The proxy 1150 relays this HTTP 200 OK status message back to the client 1120 in a fourth step.

In a fifth step, a Client Finished message, and any client handshake finalization, are sent. Specifically, the client 1120 receives the server's handshake messages from the HTTP 200 response and continues the TLS handshake process. The client 1120 verifies the certificate (if present) of the server 1180, and completes the key exchange to derive the shared secret. The client 1120 then sends a second HTTP POST request message carrying the TLS Finished message (and any other required client-side handshake messages, such as Certificate and CertificateVerify if the server requires client certificate for the authentication, if applicable). The proxy 1150 may receive this HTTP POST request message. This HTTP POST request message is again forwarded by the proxy 1150 to the server 1180, in a sixth step.

In a seventh step, a Server Finished message is sent. Specifically, the server 1180 processes the client's Finished message (verifying the handshake transcript) and completes the TLS handshake on the side of the server 1180. The server 1180 then sends a final HTTP 200 OK response message from the server 1180 to the client 1120. In an example, the proxy 1150 may receive the final HTTP 200 OK response message from the server 1180. The proxy 1150 may then forward the final HTTP 200 OK response message to the client 1120, in an eighth step. At this point, the TLS handshake is complete and both sides have established the same session secrets. The server's final response may also include an application-specific payload (for example, a success indicator, as discussed below).

This encapsulated TLS handshake maps the typical TLS 1.3 handshake flows onto HTTP messages. In a traditional TLS-over-TCP handshake, these message exchanges happen on a single persistent connection in back-and-forth record frames. By contrast, TLS-over-HTTP breaks the handshake into discrete HTTP transactions. The client and server must ensure the correct ordering and integrity of these pieces, which is guaranteed by the HTTP request/response synchronization and by TLS's own transcript verification (for example, the Finished messages cover the entire handshake transcript to detect any modification).

Latency implications are found in examples herein. Specifically, the use of HTTP as a carrier introduces additional latency compared to a native TLS handshake. Each pair of request/response constitutes a round trip through the proxy. In the above flow, a full TLS 1.3 handshake requires two HTTP round trips (Steps 1-4 and 5-8). This is comparable to the two-round-trip handshake of TLS 1.3 over TCP; however, the HTTP encapsulation adds HTTP processing overhead at the proxy and server. If the HTTP connection to the proxy was already established (e.g., the client reuses an existing TCP connection to the proxy), the additional overhead is primarily from HTTP framing and proxy forwarding. Use of persistent connections and HTTP/2 can mitigate overhead by avoiding new TCP handshakes for each message and enabling binary framing, but the sequential request/response pattern remains. There is no opportunity for the client to send the second flight (Finished) until it receives the server's response to the first flight due to HTTP's request-response synchronization. This differs from a native TLS handshake where the client's second-flight messages are sometimes sent immediately upon computing them (over the same connection) without waiting for an acknowledgment. In essence, TLS-over-HTTP introduces a brief delay while each HTTP message is delivered and processed, which could increase handshake completion time slightly in high-latency networks.

Session resumption and reuse are found in examples herein. Specifically, in traditional TLS, clients and servers often employ session resumption (via session tickets or session IDs) or zero round-trip-time (0-RTT) handshakes to reduce handshake overhead on subsequent connections. The TLS-over-HTTP design can also take advantage of these features. For example, a client that has previously completed an encapsulated TLS handshake with a given server could include a TLS 1.3 session ticket (or pre-shared key identifier) in the ClientHello message on a new handshake. The server's response would then indicate acceptance of the ticket, allowing the handshake to complete with fewer messages (no certificate exchange) and possibly in a single round trip. In an ideal case, a resumed handshake could be performed with just one HTTP request and one HTTP response. Early data (0-RTT) could even be sent by the client in the first POST (following the ClientHello data) if the protocol and application allow, though this adds complexity and comes with security considerations (replay risks). In all cases, the client and server must manage TLS session state (tickets, keys) at the application layer, since there is no persistent TLS transport session to carry over-session reuse would mean repeating the handshake via HTTP but faster. This provides a pathway to amortize the cost of handshakes across multiple requests, which is important in scenarios like 5G service-based interfaces where the same pairs of entities may interact repeatedly.

State management should be considered in examples herein. Specifically, unlike a normal TLS handshake tied to a single connection, here the handshake state is spread across multiple HTTP transactions. The client and server implementations must retain and correlate state between the first and subsequent HTTP messages. For example, when the server sends its ServerHello and other messages in the HTTP 200 OK, it must store the ongoing TLS state (cryptographic handshake context, pending secrets, etc.) so that when the client's next HTTP POST with the Finished arrives, it can resume the state and verify the Finished. The HTTP layer does not inherently provide a session continuity for these messages beyond what TCP connections and application logic ensure. Using a persistent HTTP connection (or HTTP/2 stream) for all handshake messages ensures they are delivered in order. If the underlying HTTP connection is lost mid-handshake, the handshake must be aborted and retried from scratch on a new connection. The design could include an explicit handshake identifier or cookie in the HTTP headers to help match responses to requests in complex scenarios, but in a simple request/response pattern over a single connection this is not strictly necessary. Protocol engineers should note that timeouts and error handling need careful design: e.g., if a ServerHello response is not received in time, the client may retry or abort; similarly, the server might discard handshake state if the next message is not received within a reasonable window.

In summary, TLS-over-HTTP preserves the cryptographic semantics of TLS handshaking while altering the transport mechanism. The result is a completed TLS handshake that yields shared key material, despite the presence of proxies that would normally break a direct TLS connection.

An HTTP message format is provided in examples in the following herein. A new HTTP media type, application/tls-handshake, is defined to carry TLS handshake data in HTTP messages. Both the client's requests and server's responses for the handshake use this content type (except for the final key export message which may use a different type as described below). The HTTP messages themselves can use standard HTTP/1.1 or HTTP/2 syntax. Examples provided below use HTTP/1.1 for clarity, but the use of HTTP/2 is equivalently applicable.

Examples of the ClientHello Request message are provided in the following. When initiating a handshake, the client sends an HTTP POST request to the server (targeting a known path, e.g./tls-handshake) with the TLS ClientHello bytes in the request body, with example details as follows:

POST /tls-handshake HTTP/1.1
Host: example.com
Content-Type: application/tls-handshake
Content-Length: [length]
[Serialized TLS ClientHello]

The host header indicates the server's hostname as usual in HTTP. This allows the proxy to route the request to the correct origin.

The Content-Type: application/tls-handshake signals that the payload is a TLS handshake message. The payload is a binary blob containing the exact bytes of a TLS ClientHello message (as defined in RFC 8446 for TLS 1.3, or corresponding structure for TLS 1.2 if that were used).

The Content-Length header specifies the length of the handshake message in bytes. In examples, chunked transfer-coding could also be used if appropriate, especially in HTTP/2, but typically the length is known since the handshake message is generated before sending.

The HTTP request method is POST (as opposed to GET) because examples herein are sending data in the body. From the proxy's perspective, this is just an ordinary HTTP request with an unusual content type. The proxy should forward the request like any other POST to the destination server.

Examples of the ServerHello Response message are provided in the following. The server, having processed the ClientHello, replies with an HTTP 200 OK response message carrying its TLS handshake messages, with example details as follows:

HTTP/1.1 200 OK
Content-Type: application/tls-handshake
Content-Length: [length]
[Serialized TLS ServerHello + Certificate + ...]

The status code 200 OK indicates the request was successfully processed. If the server failed to process the handshake for some reason (e.g., unsupported TLS version or invalid ClientHello), the server could respond with an HTTP error status like 400 or 500. Such error handling is analogous to TLS alert messages, but here the error would be conveyed at the HTTP layer. This specification modification would need to define how TLS alerts are mapped to HTTP responses if at all; a simple approach is to abort the HTTP exchange with an error code and possibly include an alert description in the body of the message.

The Content-Type remains application/tls-handshake for the handshake phase. The body contains the raw bytes of the TLS ServerHello message, potentially followed by other messages from the server's handshake flight. In a full TLS 1.3 handshake with certificate-based authentication, this would include one or more of: the ServerHello, the Certificate message of the server, the CertificateVerify message, the Finished message of the server, and the Content-Length.

The ServerHello contains the server's chosen protocol version, cipher suite, and key share for ephemeral Diffie-Hellman. The server's Certificate message (with the server's X.509 certificate chain) if applicable. The CertificateVerify message (the server's signature over the handshake to prove possession of the private key).

The server's Finished message may or may not be included in the handshake. In TLS 1.3, the server Finished is typically sent after the server sends all previous handshake messages. In the depicted flow above, the server's Finished was sent in the final response (Step 7). It is possible, however, to structure the handshake such that the server includes the Finished in the ServerHello response, and the final server response (Step 7) carries only an acknowledgment after the server receives the client's Finished. The chosen flow in the embodiments and examples provided herein splits them for clarity and alignment with the two-round-trip handshake structure.

The Content-Length indicates the total length of all included handshake bytes. After sending this response, the server must keep the TLS handshake state (e.g., the partial handshake transcript, the derived handshake secrets) in memory, awaiting the client's next message to complete the handshake.

Examples of the Client Finished Request message are provided in the following. Following the server's response, the client processes the server's handshake messages: it verifies the server's certificate and other parameters, and (in TLS 1.3) computes the handshake secrets and verifies the server's Finished (if the Finished was included already). The client then sends the TLS Finished message in another HTTP POST to the same endpoint with example details as follows:

POST /tls-handshake HTTP/1.1
Host: example.com
Content-Type: application/tls-handshake
Content-Length: [length]
[Serialized TLS Finished (Client)]

This request message indicates the client's handshake completion. The server, upon receiving this, will verify the client's Finished message against the expected value (which covers the entire handshake transcript). A correct Finished means the handshake is now mutually authenticated and complete.

If the TLS handshake involved client authentication (e.g., client certificates), the client's handshake flight would have included its Certificate and CertificateVerify messages before the Finished. In such a case, those messages would also be present in the body of this POST (i.e., [Serialized TLS Certificate+CertificateVerify+Finished]). The content type remains application/tls-handshake. The server would then validate the client's certificate as part of processing this payload.

Examples the Server Finished/Key Confirmation Response of message are provided in the following. Following the steps above, the server finally responds with an HTTP 200 OK message containing the server's TLS Finished message, if the Finished message was not already sent earlier. The Finished message confirms the handshake from the server side. Once the client receives and verifies this, both sides have finished the TLS handshake. At this point, no further TLS handshake messages remain; the TLS session is established.

Additionally, this final response can convey that the handshake succeeded and provide any exported key material to the client's application.

Examples of key export and usage are provided herein. One of the primary goals of performing the TLS handshake over HTTP is to obtain cryptographic keys that can be used to protect application-layer data. TLS 1.3 provides a well-defined mechanism for exporting key material from the handshake: the TLS Exporter interface (originally defined in RFC 5705 for earlier TLS and updated for 1.3). This mechanism allows the extraction of pseudorandom keys from the TLS session, bound to a specific context string to avoid cross-protocol confusion.

Examples of key derivation are provided in the following. After completing the handshake, both client and server use the shared TLS session secrets to derive application keys. This is done by invoking a TLS exporter with a custom label and desired output length. For example:
TLS-Exporter (“HTTP-Encapsulated-TLS”, context_value, key_length)

Both parties would use a label such as “HTTP-Encapsulated-TLS” (a string unique to this protocol, ensuring that keys exported for this purpose are distinguishable from keys exported for other purposes or other protocols). The context_value is an optional context string or byte sequence. Further, the context_value could be agreed in advance or be empty if not needed. The key_length is the length in bytes of the key material required. Using this exporter function (which is built into the TLS key schedule), the same output key is generated on both sides, since it relies on the shared master secret established by the TLS handshake.

For instance, the server might derive two keys of 256 bits (32 bytes) each: one for protecting client-to-server data (the client_write_key) and one for server-to-client data (the server_write_key). The server could also derive other secrets as needed. The client can perform the same derivations. The result is that both have a synchronized set of keys for encrypting and authenticating application messages. In the earlier example JSON, those keys were base64-encoded for transport; in practice, the application would handle them as binary values.

This approach leverages the strong cryptographic properties of TLS's handshake (including forward secrecy and authentication) to bootstrap symmetric keys for any application use. By using the exporter with a specific label, examples herein ensure that even if the same TLS handshake were used for another purpose, the keys would not overlap. For example, if the TLS stack wanted to generate a traffic encryption key for a real TLS connection, it would use a different label internally, so the example “HTTP-Encapsulated-TLS” exporter output is distinct.

Examples of application usage are provided herein. Once derived, these keys are not used to encrypt an underlying transport (as would normally happen in TLS, where the keys secure a TLS record layer over TCP). Instead, they are handed off to the application. The application then employs these keys to protect data on a per-message or per-field basis. Several usage scenarios may include one or more of: end-to-end encryption of messages, message authentication, or custom protocols.

In end-to-end encryption of messages, for example, if the client and server intend to exchange sensitive JSON data via subsequent HTTP requests, they can encrypt portions of that JSON using JWE (JSON Web Encryption) with the shared keys. The client could encrypt a field (such as a password or credit card number) using the client_write_key before sending an HTTP request through the proxy. The server, receiving the request, would decrypt that field using the same key (which it derived as client_write_key). Similarly, the server could encrypt its responses (or specific fields) with the server_write_key so that only the client can decrypt them. The proxy would see only ciphertext for those protected fields, while still seeing the rest of the HTTP message (such as headers or non-sensitive parts of the body) in plain text.

In an example of message authentication, using JWS (JSON Web Signature) or a similar mechanism, the keys can serve to sign data to ensure integrity and authenticity. For instance, the server could include a JWS using the server_write_key to sign the response payload or headers, allowing the client to verify that the data was not tampered with by any intermediary. This could be useful if full encryption is not desired but integrity is desired.

In an example of custom protocols, the application might define a custom usage of the keys, for example, to encrypt a series of data frames in a multimedia stream or to secure session tokens. Since the keys are available at the application layer, developers have flexibility in how to apply them, as long as both sides agree on the protocol.

Importantly, because these keys live in the application space, they must be handled with care. The next section of examples addresses the security considerations around keys in the application space.

Finally, this key export approach means that from the proxy's perspective, subsequent traffic is still “HTTP” in format, but it might be partially or fully opaque (encrypted) at the content level. For example, an HTTP request might be carrying JSON data that is encrypted and unintelligible to the proxy, even though the proxy can see the request method, uniform resource locator (URL), and other metadata. This achieves a similar security outcome to TLS-over-TCP (where the entire channel is encrypted) but allows the HTTP proxy to remain in the loop for routing and non-content-based policy enforcement. In scenarios like 5G roaming (e.g., the PRINS solution mentioned as an example), this method allows inter-network communications to gain end-to-end confidentiality without breaking the proxy-based architecture of the signaling system. Similar 6G scenarios also obtain these advantage.

In an example, a first network node encapsulates a TLS ClientHello message and a client key share in a first HTTP POST request message. Then, the first network node sends, to a second network node, the first HTTP POST request message.

Additionally or alternatively, the second network node forwards the first HTTP POST request message to a third network node. The third network node encapsulates a TLS ServerHello message, a server key share, a TLS Server Finished message, and one or more other TLS server generated messages in a first HTTP 200 OK status response message. The third network node sends the first HTTP 200 OK status response message to the second network node, which forwards the message to the first network node. In an example, the TLS Server Finished message is the last message encapsulated and sent in the first HTTP 200 OK status response message. Additionally or alternatively, the TLS Server Finished message authenticates the prior messages.

Additionally or alternatively, the first network node, upon receiving the first HTTP 200 OK status response message, encapsulates a Client Certificate message, a Certificate Verify message, and a TLS Client Finished message in a second HTTP POST request message. Additionally or alternatively, the first network node may also encapsulate one or more other TLS client generated messages in the second HTTP POST request message. Then, the first network node sends, to a second network node, the second HTTP POST request message.

Additionally or alternatively, the second network node forwards the second HTTP POST request message to a third network node. The third network node generates a second HTTP 200 OK status response message. The third network node sends the second HTTP 200 OK status response message to the second network node, which forwards the message to the first network node. Additionally or alternatively, Upon the completion of TLS handshaking exchanged over HTTP messages, the first network node and the third network node perform TLS key derivations and exporting.

Additionally or alternatively, the first network node is a client, the second network node is a proxy, and third network node is a server. Additionally or alternatively, there may be one or more other proxies between the first network node and the second network node.

Examples of security considerations are provided herein. Encapsulating TLS within HTTP inherits the security properties of TLS while introducing some new considerations due to the involvement of the HTTP layer and proxies. The TLS 1.3 handshake, when executed properly, provides mutual authentication (of server, and client if client certificates are used), confidentiality of session keys, and forward secrecy (via ephemeral Diffie-Hellman). These properties largely carry over to TLS-over-HTTP. However, the following points deserve attention by protocol designers and implementers.

The protection of exported keys is described in examples in the following. Once the TLS handshake is completed, the derived keys are available to the application. These keys must be handled securely in memory and never transmitted over the network or stored in persistent storage. In a traditional TLS implementation, the keys would stay within the TLS stack and be automatically applied to encrypt/decrypt traffic. Here, because the keys are handed to the application, there is a risk of accidental exposure (e.g., via logs, or if the application is compromised). Implementations should treat these keys as high-value secrets.

Specifically, proper implementations do not log or print the keys. Further, proper implementations store the keys in secure memory, and erase them as soon as they are no longer needed. If the environment supports hardware security modules or secure enclaves, proper implementations consider using those for key material handling.

The exported keys should be used only for the intended application-layer encryption/authentication. They should not be reused for other purposes or protocols. For instance, using the same key in both JWE encryption and some other encryption scheme could weaken security.

Because the method explicitly does not use the TLS record layer to protect data (to avoid issues with proxies), all protection comes from how the application uses the keys. It is paramount that strong cryptographic algorithms (preferably AES-GCM, ChaCha20-Poly1305, or similarly robust Authenticated Encryption with Associated Data schemes) are used with these keys to secure the data. The TLS handshake just provides the keys; it is the responsibility of the application to apply them correctly.

Examples of replay attack mitigation are provided herein. TLS 1.3 by design includes features to mitigate replay attacks and to ensure each handshake produces unique keys. Each handshake uses random nonces (ClientHello and ServerHello random values, plus the ephemeral key shares) to guarantee that the derived keys are unique to that session. Even if an attacker captured the handshake messages, the attacker could not replay the derived keys to successfully establish the same keys without being detected.

Specifically, the ClientHello contains a random value and the client's ephemeral public key (in an ECDHE exchange). The server's ServerHello contains its own random and ephemeral key. These random contributions ensure that each handshake, even with identical parameters, will produce different secrets.

If an attacker tries to replay a captured ClientHello by sending it again to the server in a new HTTP request, the server's response will include a new ServerHello random value and key share. When the attacker then tries to forward the original Client Finished, the verification will fail because the transcript and secrets do not match the new handshake. Thus, simple replay of handshake messages will not result in key reuse.

The client and server could also enforce that each HTTP-encapsulated handshake has some unique context, such as an HTTP header or a unique resource path, but this is not strictly required given built-in protections of TLS. However, one might include a timestamp or one-time token in the context (or in the context_value for the exporter) to explicitly tie a handshake to a particular session or request, adding another layer of replay defense.

If 0-RTT data is ever used with this mechanism (TLS 1.3 early data), replay considerations become very important because early data lacks full handshake protection. In such a case, the application must ensure idempotence or use anti-replay techniques. For some examples, the application may assume 0-RTT is either not used or used only in scenarios where replay is acceptable or mitigated by the application.

Examples of proxy handling and trust are provided in the following. The presence of an HTTP proxy in the path is a reason for this protocol, but this presence also represents a potential threat or point of failure.

Specifically, the HTTP proxy may provide a potential threat to the integrity of handshake messages. Proxies should not inspect or modify the encapsulated TLS handshake messages. A well-behaved proxy will treat the application/tls-handshake content as opaque binary data and just forward it. If a proxy were to drop or alter any of these bytes, the TLS handshake would almost certainly fail, as the Finished message includes a hash of the entire handshake. Thus, any meddling can be detected by the endpoints. As a result, the handshake would not complete successfully. This is good from a security standpoint (since it is hard for an attacker in the middle to silently tamper), but it also means that some middle-boxes might inadvertently break the connection if they do anything other than pass the data unchanged. It is assumed in this design that proxies in the target environments are willing to forward such traffic (they may not understand it, but they also have no reason to block it as it is valid HTTP traffic). Using a recognizable media type like application/tls-handshake could help some proxies identify this as a known safe protocol to forward (if standardized), or it could potentially flag unusual traffic. Care should be taken in deployment. In example deployments, if issues arise, one might consider fallback strategies (e.g., if a proxy blocks application/tls-handshake content, the client might fall back to a plain HTTP exchange or an alternative mechanism).

Further, the HTTP proxy may provide a potential threat to message confidentiality and may have potential visibility into a message. Unlike a normal TLS tunnel (which would encrypt everything from the client to server), here the TLS handshake messages are effectively sent in cleartext (the handshake is not encrypted, except for parts of TLS 1.3 handshake like encrypted extensions after the ServerHello). This means a proxy could observe certain metadata in the handshake. For example, the ClientHello contains the Server Name Indication (SNI) extension in plaintext (unless Encrypted Client Hello (ECH) is used, which is an extension that could theoretically be employed here if both client and server support it). The proxy, seeing the handshake, might learn which hostname the client is trying to ultimately talk to (though it already knows the Host header from the HTTP request, which is typically the same). The proxy might also see the list of cipher suites the client supports, TLS version, etc. This is information that normally the proxy would not see if a CONNECT tunnel was used (because then the TLS handshake would be inside the tunnel). However, this is a minor information leak; generally, cipher lists are not sensitive information. If this is a concern, future enhancements like TLS Encrypted Client Hello (RFC 9337 draft or future RFC) could be considered, but such enhancements may add complexity and require proxy tolerance for unknown TLS patterns. In any case, after the handshake, the actual application data that the client and server exchange can be encrypted with the derived keys, so the proxy will not see the sensitive payload (only its size and perhaps timing).

Also, the HTTP proxy may provide a potential threat of active man-in-the-middle (MITM) proxies. Some enterprise or carrier scenarios employ intercepting proxies that present their own certificates to the client (essentially performing a TLS man-in-the-middle for inspection purposes). How would such a proxy interact with TLS-over-HTTP? If a proxy is truly determined to intercept, it could attempt to terminate the encapsulated handshake just as it would a normal TLS connection. To do so, the proxy would need to understand the protocol: it would read the ClientHello from the HTTP request, generate its own ServerHello/Certificate pretending to be the server (using a certificate the client trusts, e.g., issued by an enterprise certificate authority (CA) that is trusted by the client), and respond to the client. Then the proxy may complete the handshake with the client, and separately initiate a new encapsulated handshake with the real server. Essentially, the proxy would be acting as a TLS-over-HTTP endpoint itself, bridging two handshake instances. This is not trivial and would require the proxy to implement this entire specification logic (which today, proxies do not). If it did, the end-to-end security would be broken (the proxy would get the keys instead of the true endpoints, similar to normal TLS interception). The client might or might not detect this; if the proxy's fake certificate is trusted (like a corporate CA), the client will think it's talking to the server and won't know the difference. In environments where such proxies exist, one might question why use TLS-over-HTTP at all since the proxy could just allow CONNECT and intercept the normal TLS—but there could be policy reasons.

In any case, this possibility should be acknowledged: the method is not magically immune to active interception by proxies that are designed to intercept TLS, the method merely changes the game slightly. The assumption is that in many scenarios (e.g., internet service provider (ISP) or content delivery network (CDN) proxies, or 5G roaming proxies), full interception is not done. Instead the proxies simply disallow end-to-end TLS by blocking CONNECT, so this protocol provides a workaround in those contexts. If a network is hostile enough to actively MITM TLS-over-HTTP, then end-to-end security can only be achieved if the client can detect the MITM (for example, by validating the true server certificate via an out-of-band mechanism or expecting the exported keys to match some known value, etc.).

Moreover, the HTTP proxy may provide a potential threat of content modification. Accordingly, examples herein ensure no proxy modification of content. After the handshake, when application data is flowing (potentially encrypted at the application layer), proxies might be tempted to modify or sanitize content (e.g., an HTTP proxy might normally rewrite headers or block certain content). If the content is encrypted (e.g., as a JWE payload), any modification by the proxy will render it undecryptable or the signature invalid at the receiver. This is analogous to a proxy trying to modify TLS-encrypted traffic; the proxy cannot do so without being detected. So, proxies must either leave the content untouched or decrypt it (which they cannot unless they intercept the handshake as discussed). Therefore, in deploying this method, one should ensure proxies are configured to allow this traffic through without attempting data modifications or content filtering on the encrypted portions. They can still do filtering on unencrypted parts (like URLs, or headers if those remain in plaintext), which maintains some of their value-added functionality, but full content filtering would be incompatible with end-to-end encryption.

In summary, the security model here assumes an honest-but-curious proxy: one that will forward data as instructed but does not have the capability (or permission) to alter or decrypt the protected content. Under that assumption, the TLS-over-HTTP handshake achieves a level of security comparable to standard TLS. Critical security material (for example, the keys) remains confined to the endpoints, and any interference by the proxy is detectable and will abort the session.

Examples of compatibility and interoperability of the example solutions are provided herein. This protocol is designed to work within the existing web and networking infrastructure with minimal special support. This protocol can operate with different HTTP versions, different TLS versions, different application protocols, no impact on proxies, multi-hop scenarios, and interaction with encryption on other layers.

Specifically, this protocol can operate over the HTTP versions of HTTP/1.1 or HTTP/2. HTTP/1.1 is illustrated in the examples herein, using separate requests for each message. HTTP/1.1 persistent connections should be used to avoid reopening TCP for each handshake message. In HTTP/2, the same exchange would be conducted over a single stream with the binary frames carrying the TLS handshake bytes (the content type travels as an HTTP header as usual). The method does not rely on any HTTP/2-specific feature except header compression/multiplexing, so HTTP/1.1 proxies are equally supported. HTTP/3 (which runs over quick UDP Internet connections (QUIC)) could theoretically transport these messages as well, although if HTTP/3 were available end- to-end, one might simply use QUIC's built-in TLS handshake. The focus here is on HTTP/1.1/2 since those are prevalent in proxy environments today.

Further, this protocol can operate over TLS Versions of TLS 1.3 or earlier, with later or future TLS Versions a possibility. TLS 1.3 is the focus (per RFC 8446) of examples provided herein, as it provides modern security features and efficient handshakes. The example methods herein are also applicable to earlier TLS versions (TLS 1.2 or even 1.1) if needed, with the handshake messages encapsulated similarly. However, older TLS versions lack some of the exporter and perfect forward secrecy (PFS) benefits; for instance, TLS 1.2 does support exporters (RFC 5705) but does not provide 0-RTT or built-in forward secrecy unless extensions like RFC 7627 (extended master secret) are used. In any case, nothing in this mechanism inherently breaks compatibility with TLS 1.2 handshakes, though those are not recommended for new deployments due to known security weaknesses in older versions and cipher suites.

Also, this protocol can operate with different application protocols or with different use of key. The keys derived can be used with any application-layer security scheme the endpoints agree on. Examples provided herein specifically mention JWE (RFC 7516) and JWS (RFC 7515) as they are standardized ways to encrypt and sign JSON-based data, common in web application programming interfaces (API) s and services (like those in 5G service-based architectures). But one could also use the keys for a custom binary protocol, or even to feed them into a conventional TLS record layer if one were, say, to spin up a secondary TLS connection (this last approach is not typical, since it would defeat the purpose by requiring CONNECT-like tunneling to carry that secondary connection unless one did something like WebSocket, see discussion below herein). The contents of RFC 7515 are incorporated by reference herein as if fully set forth in their entirety.

Moreover, this protocol can operate with no impact on proxies. Because examples provided herein are using legitimate HTTP requests and responses, any standard HTTP proxy will forward these messages as long as it is configured to allow POST to the specific path. There is no need for proxies to implement new methods or protocols (unlike proposals such as extended CONNECT or MASQUE for UDP proxying). Proxies that obey HTTP semantics will either treat the application/tls-handshake like an arbitrary data payload (which is fine), or at most log it or perform multipurpose Internet mail extensions (MIME) type checks. Some proxy software might need a configuration tweak to allow unfamiliar MIME types or large request bodies, but generally this is standard web traffic from their perspective. The approach is interoperable with caching proxies as well, but since these requests use POST and are meant to be end-to-end (and include dynamic content), proxies should not cache them. (It would be unusual for a proxy to cache a POST response without explicit headers allowing it.)

Further, this protocol can operate with multi-hop scenarios. Specifically, in some complex deployments, there might be multiple proxies in the path (e.g., a chain of proxies, or a client-side proxy and a server-side load balancer, etc.). As long as each element forwards HTTP messages properly, this method works through multiple hops as well. Each proxy just sees HTTP messages. Even translation proxies (e.g., an HTTP/1.1 proxy that communicates with an upstream using HTTP/2) should not break anything, because they will preserve the content of payload and headers.

Also, the protocol may include interaction with encryption at other layers. If the client is already using HTTPS to talk to the proxy (for instance, some setups have a TLS connection between client and proxy for confidentiality within a network), then HTTP messages in examples herein would actually be traveling inside an HTTPS connection up to the proxy. In that case, from the proxy onward, it might be plain HTTP to the server. This is fine; it means the TLS handshake messages get a layer of encryption on the first leg (client-to-proxy TLS), then are exposed at the proxy and forwarded to the server over another TLS or TCP connection depending on whether the proxy connects via HTTPS or HTTP to the server. Ultimately, the security between the true client and true server comes only from the encapsulated handshake. So, even if the client-proxy link is the only secure link in the transport layer, examples provided herein based on the end-to-end derived keys from TLS still provide application data protection across the entire path.

In summary, TLS-over-HTTP as described is deliberately designed to minimize required infrastructure changes. Clients and servers need new logic to package/unpackage TLS handshakes in HTTP, and to use the resulting keys. Proxies remain largely oblivious. This makes the scheme attractive for incremental deployment in today's Internet and in telecom networks where upgrading proxy behavior is difficult.

The embodiments and examples provided herein include trade-offs and alternative approaches. The approach provided herein of encapsulating TLS handshakes in HTTP is an innovative solution to a specific problem (the inability to create end-to-end TLS tunnels through certain proxies). It is important to understand the trade-offs involved and to compare this solution to alternative methods, in order to appreciate where it is most appropriate.

The examples provided herein include performance and complexity trade-offs. Carrying TLS over HTTP adds overhead in multiple dimensions.

Specifically, carrying TLS over HTTP adds message overhead. Each TLS handshake message is wrapped in HTTP, which means additional headers and potentially larger payload (e.g., base64 encoding if used in some contexts, though the example designs herein send binary data raw in the HTTP body). This overhead is relatively small (HTTP headers on the order of tens to hundreds of bytes), but it is not zero. If many handshakes are done, the extra bytes could add up. There is also some duplication of information: for instance, the Host header and the SNI in the ClientHello both essentially indicate the server's identity.

Further, carrying TLS over HTTP may add latency. As discussed, the sequential request-response nature may add latency. A standard TLS 1.3 handshake takes one round-trip (after TCP handshake) in an ideal scenario. The example design herein takes two HTTP round-trips for a full handshake, which might be slightly more than the ideal but similar to TLS over TCP when TCP handshake and network delays are considered. Where it does add latency is in additional processing at application layer: the server has to receive an HTTP request, dispatch it to the TLS handling code, then formulate a response, etc., instead of having all that happen in the kernel or TLS library layer. This likely adds a few milliseconds of processing overhead on each end, which for many applications is acceptable. There is also the potential for head-of-line blocking if the HTTP connection is used for other traffic concurrently (especially in HTTP/2 where multiple streams share one TCP connection—if the TLS handshake stream is slow, it might in theory impact others, though HTTP/2 has mechanisms to mitigate this). In summary, there is some latency cost, but in environments where this is needed (mobile core networks, etc.), the benefits of security likely outweigh a small latency hit.

Also, carrying TLS over HTTP may add implementation complexity. Perhaps the biggest cost is that this approach requires custom handling in client and server software. A standard TLS library expecting to run over a socket needs to be adapted or called in a different way. The application (or a middleware library) must take on the role of transporting handshake bytes via HTTP. This is more complex than simply calling SSL_connect() on a socket. On the server side, the HTTP server needs to route the handshake POST (e.g., to a specific endpoint) to a component that runs the TLS handshake and returns a response. This might be implemented as a servlet, an API handler, or a plugin to an HTTP server. Essentially, the server performs a user-space TLS termination for the handshake, rather than relying on the operating system (OS) or web server's built-in TLS at the transport layer. While this complexity is justified in scenarios where the network will not allow normal TLS. In more open scenarios, it is obviously simpler to use regular TLS.

Moreover, carrying TLS over HTTP may result in a loss of automatic encryption. In normal TLS, once the handshake is done, all bytes are automatically encrypted by the TLS record layer. In examples herein, after the handshake, the channel between client and proxy, and proxy to server remains “open” HTTP. It is up to the application to encrypt content. This means developers must be careful to actually use the keys everywhere needed. If any sensitive data is sent without using the keys (inadvertently or due to legacy behavior), it will go in clear through the proxy. In other words, the approach introduces room for human error in applying encryption consistently. By contrast, with TLS, once it is on, nothing leaks unless explicitly bypassed. Protocol engineers designing systems with TLS-over-HTTP must enforce at the application level that certain data never leaves the endpoints unprotected by the derived keys. One could define profiles or rules, for example: “All API calls of type X must have their payload encrypted with the session key, otherwise the server will reject them.” This ensures that the security level is equivalent to TLS. It is a new layer of protocol design that TLS channel users normally do not face.

Despite these overheads and complexities, TLS-over-HTTP has a key advantage: it works within existing proxy-restricted architectures without requiring cooperation from those proxies. Alternative approaches each have their own limitations, as noted in the following.

Using HTTP CONNECT may be considered to be the baseline solution. Specifically, the straightforward solution for TLS through a proxy is the HTTP CONNECT method, which instructs the proxy to open a TCP tunnel to the target server and then passes through the TLS handshake. This was not chosen (and often is not available) due to the reasons outlined in discussions above herein: proxies often disallow a TCP tunnel to avoid losing visibility. In scenarios where CONNECT is allowed (e.g., a corporate proxy that wants to allow TLS out, perhaps with interception), one might not need TLS-over-HTTP at all. TLS-over-HTTP is aimed at the cases where CONNECT is off the table.

QUIC and HTTP/3: QUIC is a modern transport protocol that integrates TLS 1.3 handshake directly into a UDP-based transport. HTTP/3, in turn, runs over QUIC. One might ask, if QUIC inherently uses TLS and might circumvent some TCP-based proxy limitations, could QUIC be a solution? QUIC does offer faster handshakes and improved performance (it combines transport and TLS handshakes into one, reducing round trips). However, QUIC has its own deployment challenges, described in the following.

Many proxies and firewalls block or do not support QUIC/UDP traffic. In fact, enterprise network administrators often block QUIC intentionally to force traffic back to TCP/TLS where it can be inspected. QUIC traffic on UDP port 443 might be dropped or throttled, causing clients to fall back to TLS over TCP. In a 5G core or similar environment that mandates HTTP/2, QUIC is typically not allowed unless explicitly built into the architecture.

Even if QUIC were allowed, using QUIC end-to-end would negate the proxy's ability to see any of the traffic (since QUIC encrypts everything, including packet headers to some degree). This is the same fundamental issue from the proxy's perspective as TLS-over-TCP: the proxy loses visibility and control. So a proxy that doesn't allow CONNECT is also unlikely to allow QUIC traffic freely. The TLS-over-HTTP approach, by contrast, keeps the proxy in the HTTP loop (the proxy sees HTTP methods, URLs, and can enforce policies, except on the encrypted fields).

QUIC is a transport protocol requiring client and server support at the OS or library level, whereas our method can be implemented at the application level on top of existing HTTP libraries. In scenarios where introducing QUIC is impractical (e.g., an environment standardized on HTTP/2 and TCP), TLS-over-HTTP can be layered without lower-level network stack changes.

Performance-wise, QUIC excels in low-latency setup and multi-streaming. But if QUIC is not an option due to network policy, its specific benefits cannot be realized at all. TLS-over-HTTP does not offer the same performance gains as QUIC; in fact it slightly increases latency as discussed. So it is a trade-off of some performance for the ability to function at all in proxy-restricted contexts.

In summary, QUIC/HTTP3 is an excellent protocol where it can be used. It is essentially the next-gen solution for transport security on the open Internet; but in controlled networks (like carrier cores or enterprises with strict proxies), it may be blocked or unsupported, making it a non-starter. TLS-over-HTTP is more of a surgical solution for those environments.

Another alternative approach could be to use WebSocket, which is an HTTP upgrade mechanism that turns an HTTP connection into a persistent, bidirectional binary pipe (and other tunneling inside HTTP may also be used). One could imagine the client doing GET/somepath Upgrade: websocket, establishing a WebSocket through the proxy (if the proxy allows it), and then running a normal TLS handshake over that WebSocket connection. This is conceptually similar to CONNECT (a tunnel), just using WebSocket semantics. Some proxies do allow WebSocket traffic since it is used for web applications (though proxies could also inspect or filter it). The downside is similar: once the WebSocket is established and raw TLS bytes start flowing, the proxy loses visibility. There is also the complexity of implementing TLS on top of WebSocket framing (which is doable, effectively treating the WebSocket as a stream). In practice, WebSocket might succeed in some environments and fail in others. TLS-over-HTTP as specified here does not create a long-lived opaque tunnel; it only passes specific messages and then goes back to normal HTTP. This may be more palatable to proxies and easier to integrate into request/response application patterns (e.g., a client can intermix other API calls via the same proxy without multiplexing into one tunnel).

A further alternative approach could be custom key exchange protocols. One could design a custom key agreement at the application layer (for instance, performing a Diffie-Hellman exchange via HTTP messages, without using TLS formats). In fact, the 3GPP mobile network standards considered some custom approaches for securing inter-network messages. Designing a new cryptographic protocol, however, is risky and unnecessary when TLS already provides a well-vetted solution. By encapsulating TLS, we leverage decades of analysis and implementation experience. It reduces the likelihood of introducing cryptographic flaws. The trade-off is that TLS handshake messages are somewhat large and not tailored for this specific scenario (they include capabilities and negotiation that might be superfluous in some cases). A custom protocol could be leaner, but it would require its own security analysis and likely not be as robust as TLS 1.3, which has formal verification and widespread scrutiny. So, using TLS is a way to stand on the shoulders of an existing standard. Additionally, using TLS means we can potentially plug in future enhancements (like post-quantum key exchange algorithms, or new cipher suites) by simply allowing those in the TLS handshake. Example solutions provided herein including encapsulation would not need changes to support new algorithms, whereas a custom protocol would.

Moreover, MASQUE and HTTP/2/3 Extended CONNECT may provide an alternative approach. For example, the IETF MASQUE working group is developing methods to proxy UDP and even IP over HTTP/3, and extended CONNECT methods (like CONNECT-UDP) exist to allow sending UDP traffic through an HTTP proxy. If those were deployed, one could theoretically use CONNECT-UDP to send QUIC through a proxy, or even send a TLS-over-TCP connection through an HTTP/3 proxy in a similar way. These are cutting-edge approaches and require support from proxies (which currently is rare). Again, in environments like 5G networks, introducing MASQUE would require upgrading the proxy infrastructure significantly. TLS-over-HTTP, in contrast, is deployable on top of today's proxy infrastructure by just updating endpoints.

In weighing these alternatives, the encapsulated TLS approach is not necessarily aimed at replacing standard TLS or QUIC where those work, but rather providing a method where those do not work due to policy. Its niche is exactly those “proxy-limited architectures” where security is desired but network operators won't allow a straight tunnel.

For protocol engineers considering this approach, the decision comes down to the context: If you control the network and can allow QUIC or CONNECT, it's simpler to use them. If you are operating in someone else's network (an ISP, a partner's network, a roaming scenario) where you have to live with proxy restrictions, TLS-over-HTTP might be the tool that enables end-to-end security when nothing else can. It trades a bit of efficiency for deployability.

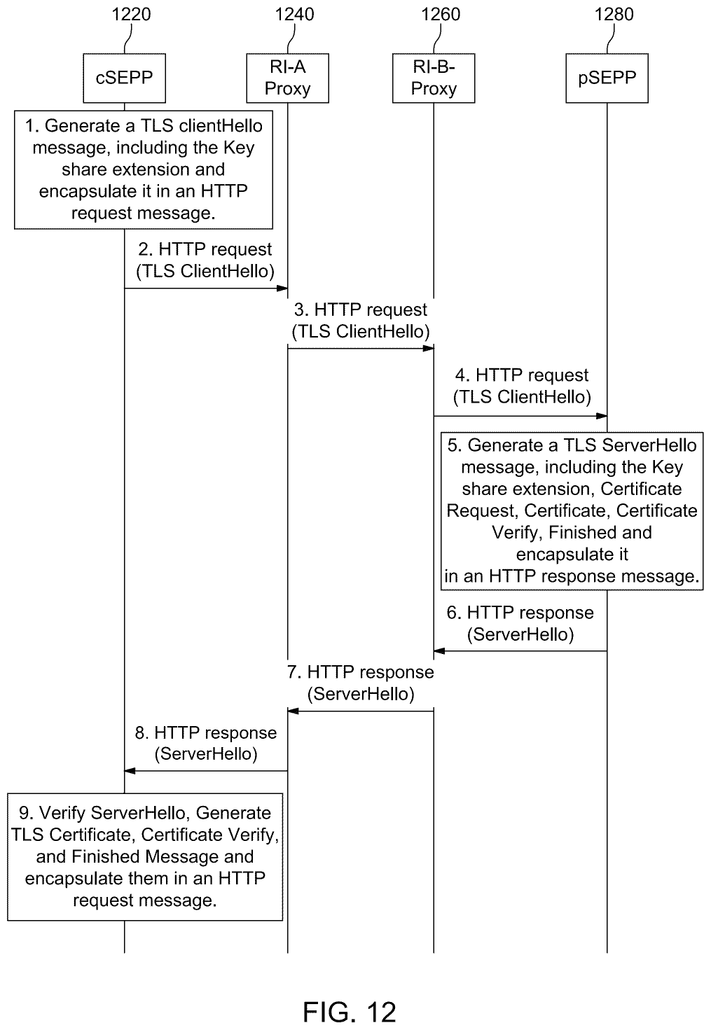

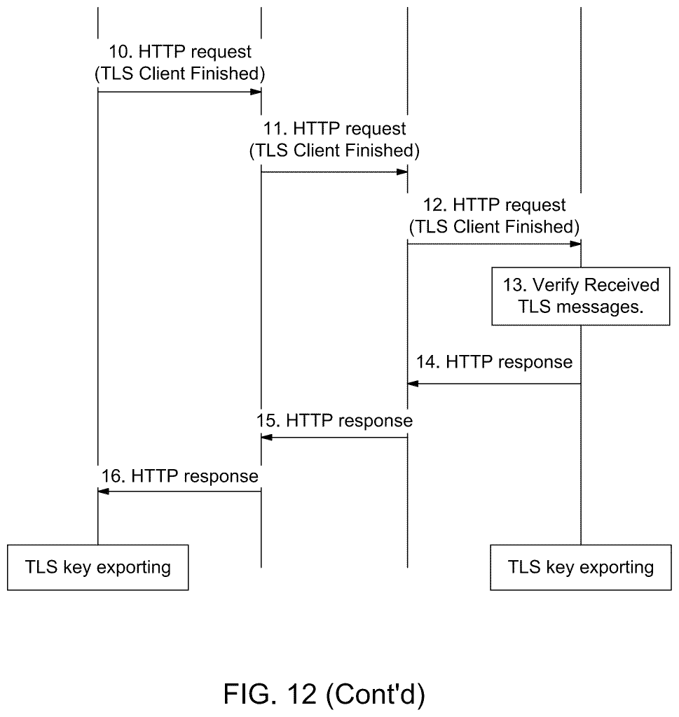

FIG. 12 illustrates an example of the architecture for a transport layer security (TLS) handshake procedure initiated by a cSEPP. As shown in an example in FIG. 12, a cSEPP 1220 may initiate this key exchange procedure, including one or more steps in the following.

In a first step, the cSEPP 1220 shall generate a TLS ClientHello message. Additionally or alternatively, the TLS ClientHello message includes the Key share extension. Further, the cSEPP 1220 will encapsulate the TLS ClientHello message in an HTTP request message. Additionally or alternatively, the cSEPP 1220 will encapsulate the key share extension in the HTTP request message. Additionally or alternatively, the cSEPP 1220 will encode the TLS ClientHello message in an HTTP request message. Additionally or alternatively, the cSEPP 1220 shall protect the TLS ClientHello message with JWS using digital signature.

In a second step, the cSEPP 1220 shall send the TLS ClientHello in an HTTP request to an RI-A Proxy 1240 over TLS. In a third step, the RI-A 1240 shall send the TLS ClientHello in an HTTP request to an RI-B Proxy 1260 over TLS. In a fourth step, the RI-B 1260 shall send the TLS ClientHello in an HTTP request to a pSEPP 1280 over TLS.

In a fifth step, the pSEPP 1280 shall generate a TLS ServerHello message, including the Key share extension, Certificate Request, Certificate, Certificate Verify and Finished messages. Further, the pSEPP 1280 shall encode the TLS ServerHello message in an HTTP response message. Additionally or alternatively, the pSEPP 1280 shall protect the TLS ServerHello message with JWS using digital signature.

In a sixth step, the pSEPP 1,280 shall send the TLS ServerHello message to the RI-B Proxy 1260 over TLS. In a seventh step, the RI-B 1260 shall send the TLS ServerHello message to the RI-A Proxy 1240 over TLS. In an eighth step, the RI-A 1240 shall send the TLS ServerHello message to the cSEPP 1220 over TLS. As a result, the cSEPP 1220 may receive the TLS ServerHello message.

In a ninth step, the cSEPP 1,20 will verify the ServerHello message. If the ServerHello message satisfies the cSEPP 1220 verification, then the cSEPP 1220 will generate a TLS Client Finished message. Additionally or alternatively, the cSEPP 1220 will generate a TLS Certificate and Certificate Verify. Then, the cSEPP 1220 will encode the TLS messages in an HTTP request message. Additionally or alternatively, the cSEPP 1220 may protect the HTTP response message with JWS using digital signature.

In a tenth step, the cSEPP 1220 shall send the TLS Client Finished message in an HTTP request to the RI-A Proxy 1240 over TLS. The HTTP request message sent to the RI-A Proxy 1240 may include the TLS Certificate and the Certificate Verify. In an eleventh step, the RI-A 1240 shall send the received HTTP request including the TLS Certificate, Certificate Verify, and TLS Client Finished messages to the RI-B Proxy 1260 over TLS. In a twelfth step, the RI-B 1260 shall send the received HTTP request including the TLS Certificate, Certificate Verify, and TLS Client Finished messages to the pSEPP 1280 over TLS.

In a thirteenth step, the pSEPP 1280 will verify the received TLS messages. For example, the pSEPP 1280 will verify one or more of the TLS Client Finished message, the TLS Certificate, and the TLS Certificate Verify. If the pSEPP 1,280 is satisfied with the verification, the pSEPP 1280 will proceed to the next steps.

In a fourteenth step, the pSEPP 1280 will send an HTTP response to the RI-B 1260. As a result, the RI-B 1260 will send an HTTP response to the RI-A 1240, in a fifteenth step. Consequently, the RI-A 1240 will send an HTTP response to the cSEPP 1220, in a sixteenth step. In a final step, the cSEPP 1220 and pSEPP 1280 will perform TLS key exporting.

Additionally or alternatively, the HTTP requests used above may be hypertext transfer protocol secure (HTTPS) requests. Additionally or alternatively, the HTTP responses used above may be HTTPS responses.

In another example, a first network node generates a TLS ClientHello message Further, the first network node encapsulates the TLS ClientHello message, a client key share and one or more other TLS extensions in a first HTTP request message. Also, first network node sends, to a second network node, the first HTTP request message.

Additionally or alternatively, the second network node forwards the first HTTP request message to a third network node. The third network node forwards, to a fourth network node, the first HTTP request message.

The fourth network node generates a TLS ServerHello message. Also, the fourth network node encapsulates the TLS ServerHello, a server key share, a TLS Server Finished message, and one or more other TLS server generated messages in a first HTTP response message. Moreover, the fourth network node sends, to the third network node, the first HTTP response message.

Additionally or alternatively, the third network node forwards, to the second network node, the first HTTP response message. The second network node forwards, to the first network node, the first HTTP response message.

Additionally or alternatively, the first network node verifies the TLS ServerHello message. Additionally or alternatively, first network node generates a TLS Client Finished message. Additionally or alternatively the first network node generates the TLS Client Finished message on a condition that the TLS ServerHello message, is verified. The first network node encapsulates a Client Certificate message, a CertificateVerify message, and the TLS Client Finished message in a second HTTP request message. Moreover, the first network node sends, to the second network node, the second HTTP request message.

Additionally or alternatively, the second network node forwards, to the third network node, the second HTTP request message. The third network node forwards, to the fourth network node, the second HTTP request message. Additionally or alternatively, the fourth network node verifies the TLS Client Finished message. Moreover, the fourth network node sends, to the third network node, a second HTTP response message.

Additionally or alternatively, the third network node forwards, to the second network node, the second HTTP response message. The second network node forwards, to the first network node, the second HTTP response message;

The first network node performs key exporting. Further, the fourth network node performs key exporting. Additionally or alternatively, the HTTP requests used above may be HTTPS requests. Additionally or alternatively, the HTTP responses used above may be HTTPS responses.

Additionally or alternatively, the first network node is a consumer's Security Edge Protection Proxy (SEPP) (cSEPP). Additionally or alternatively, the second network node is a first roaming intermediary (RI) Proxy. Additionally or alternatively, the third network node is a second RI Proxy. Additionally or alternatively, the fourth network node is a producer's SEPP (pSEPP).

Embodiments and examples provided herein define a method to perform a TLS 1.3 (or earlier) handshake over HTTP, enabling applications to negotiate keys in environments where direct TLS connections are impeded by proxies. Further, examples encapsulate TLS handshake messages inside HTTP requests and responses so that standard HTTP proxies will forward them, thereby establishing end-to-end cryptographic key material without requiring proxy cooperation such as CONNECT tunneling. The derived keys from the handshake can then be used at the application layer (for encryption, authentication, etc.) to protect data exchanges with confidentiality and integrity akin to TLS.

This example solution addresses real-world scenarios on the Internet and in emerging 5G/6G networks where security must be balanced with operational constraints. It maintains clarity and rigor of the TLS protocol while adapting it to proxy-restricted environments. Although it introduces some performance and complexity trade-offs, it leverages well-established cryptographic practices to ensure that security is not compromised. By using TLS exporters and existing standards like JWE/JWS for data protection, the approach provides a flexible yet robust framework for end-to-end security.

In summary, TLS-over-HTTP offers a practical compromise: it upholds end-to-end security in challenging network conditions, without requiring a wholesale upgrade of middleboxes, and thus stands as a viable technique for protocol engineers designing secure systems in the proxy-rich networks of both today and tomorrow.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A system comprising:
a first network node comprising:
a first processor; and
a first communications interface operatively coupled to the first processor; wherein:
the first processor is configured to encapsulate a transport layer security (TLS) ClientHello message, a client key share, and one or more other TLS extensions in a first hypertext transfer protocol (HTTP) POST request message; and
the first processor and the first communications interface are configured to send, to a second network node, the first HTTP POST request message.

2. The system of claim 1, wherein the system further comprises the second network node, wherein the second network node comprises:
a second processor; and
a second communications interface operatively coupled to the second processor; wherein:
the second processor and the second communications interface are configured to receive, from the first network node, the first HTTP POST request message; and
the second processor and the second communications interface are configured to forward, to a third network node, the first HTTP POST request message.

3. The system of claim 2, wherein the system further comprises the third network node, wherein the third network node comprises:
a third processor; and
a third communications interface operatively coupled to the third processor; wherein:
the third processor and the third communications interface are configured to receive, from the second network node, the first HTTP POST request message;
the third processor is configured to encapsulate a TLS ServerHello message, a server key share, a TLS Server Finished message, and one or more other TLS server generated messages in a first HTTP 200 OK status response message; and
the third processor and the third communications interface are configured to forward, to the second network node, the first HTTP 200 OK status response message.

4. The system of claim 3, wherein in the second network node:
the second processor and the second communications interface are further configured to receive, from the third network node, the first HTTP 200 OK status response message; and
the second processor and the second communications interface are further configured to forward, to the first network node, the first HTTP 200 OK status response message.

5. The system of claim 4, wherein in the first network node:
the first processor and the first communications interface are further configured to receive, from the second network node, the first HTTP 200 OK status response message;
and the first processor is further configured to encapsulate a Client Certificate message, a CertificateVerify message, and a TLS Client Finished message in a second HTTP POST request message; and
the first processor and the first communications interface are further configured to send, to the second network node, the second HTTP POST request message.

6. The system of claim 5, wherein:
in the second network node:
the second processor and the second communications interface are further configured to receive, from the first network node, the second HTTP POST request message; and
the second processor and the second communications interface are further configured to forward, to the third network node, the second HTTP POST request message;
in the third network node:
the third processor and the third communications interface are configured to receive, from the second network node, the second HTTP POST request message;
the third processor is configured to generate a second HTTP 200 OK status response message; and
the third processor and the third communications interface are configured to forward, to the second network node, the second HTTP 200 OK status response message;
in the second network node:
the second processor and the second communications interface are further configured to receive, from the third network node, the second HTTP 200 OK status response message; and
the second processor and the second communications interface are further configured to forward, to the first network node, the second HTTP 200 OK status response message.

7. The system of claim 3, wherein the first network node is a client, the second network node is a proxy, and third network node is a server.

8. A method for use in a system, the method comprising:
in a first network node:
encapsulating a transport layer security (TLS) ClientHello message, a client key share, and one or more other TLS extensions in a first hypertext transfer protocol (HTTP) POST request message; and
sending, to a second network node, the first HTTP POST request message.

9. The method of claim 8, further comprising:
in a second network node:
receiving, from the first network node, the first HTTP POST request message; and
forwarding, to a third network node, the first HTTP POST request message.

10. The method of claim 9, further comprising:
in a third network node:
receiving, from the second network node, the first HTTP POST request message;
encapsulating a TLS ServerHello message, a server key share, a TLS Server Finished message, and one or more other TLS server generated messages in a first HTTP 200 OK status response message; and
forwarding, to the second network node, the first HTTP 200 OK status response message.

11. The method of claim 10, further comprising:
in the second network node:
receiving, from the third network node, the first HTTP 200 OK status response message; and
forwarding, to the first network node, the first HTTP 200 OK status response message.

12. The method of claim 11, further comprising:
in the first network node:
receiving, from the second network node, the first HTTP 200 OK status response message; and
encapsulating a Client Certificate message, a CertificateVerify message, and a TLS Client Finished message in a second HTTP POST request message; and
sending, to the second network node, the second HTTP POST request message.

13. The method of claim 12, further comprising:
in the second network node:
receiving, from the first network node, the second HTTP POST request message; and
forwarding, to the third network node, the second HTTP POST request message;
in the third network node:
receiving, from the second network node, the second HTTP POST request message;
generating a second HTTP 200 OK status response message; and
forwarding, to the second network node, the second HTTP 200 OK status response message;
in the second network node:
receiving, from the third network node, the second HTTP 200 OK status response message; and
forwarding, to the first network node, the second HTTP 200 OK status response message.

14. The method of claim 10, wherein the first network node is a client, the second network node is a proxy, and third network node is a server.

15. A system comprising:
a first network node comprising:
a first processor; and
a first communications interface operatively coupled to the first processor; wherein:
the first processor is configured to encapsulate a transport layer security (TLS) ClientHello message, a client key share, and one or more other TLS extensions;
in a first hypertext transfer protocol (HTTP) request message; and
the first processor and the first communications interface are configured to send, to a second network node, the first HTTP request message.

16. The system of claim 15, wherein:
the system further comprises the second network node, wherein the second network node comprises:
a second processor; and
a second communications interface operatively coupled to the second processor; wherein:
the second processor and the second communications interface are configured to receive, from the first network node, the first HTTP request message; and
the second processor and the second communications interface are configured to forward, to a third network node, the first HTTP request message; and
the system further comprises the third network node, wherein the third network node comprises:
a third processor; and
a third communications interface operatively coupled to the third processor; wherein:
the third processor and the third communications interface are configured to receive, from the second network node, the first HTTP request message; and
the third processor and the third communications interface are configured to forward, to a fourth network node, the first HTTP request message.

17. The system of claim 16, wherein the system further comprises the fourth network node, wherein the fourth network node comprises:
a fourth processor; and
a fourth communications interface operatively coupled to the third processor; wherein:
the fourth processor and the fourth communications interface are configured to receive, from the third network node, the first HTTP request message;
the fourth processor is configured to encapsulate a TLS ServerHello message, a server key share, a TLS Server Finished message, and one or more other TLS server generated messages in a first HTTP response message; and
the fourth processor and the fourth communications interface are configured to send, to the third network node, the first HTTP response message.

18. The system of claim 17, wherein:
in the third network node:
the third processor and the third communications interface are further configured to receive, from the fourth network node, the first HTTP response message; and
the third processor and the third communications interface are further configured to forward, to the second network node, the first HTTP response message; and
in the second network node:
the second processor and the second communications interface are further configured to receive, from the third network node, the first HTTP response message; and
the second processor and the second communications interface are further configured to forward, to the first network node, the first HTTP response message.

19. The system of claim 18, wherein
in the first network node:
the first processor and the first communications interface are further configured to receive, from the second network node, the first HTTP response message;
the first processor is further configured to encapsulate a Client Certificate message, a CertificateVerify message, and a Client Finished message in a second HTTP request message; and
the first processor and the first communications interface are further configured to send, to the second network node, the second HTTP request message; and
in the second network node:
the second processor and the second communications interface are further configured to receive, from the first network node, the second HTTP request message; and
the second processor and the second communications interface are further configured to forward, to the third network node, the second HTTP request message; and
in the third network node:
the third processor and the third communications interface are further configured to receive, from the second network node, the second HTTP request message; and
the third processor and the third communications interface are further configured to forward, to the fourth network node, the second HTTP request message; and
in the fourth network node:
the fourth processor and the fourth communications interface are further configured to receive, from the third network node, the first HTTP request message; and
the fourth processor and the fourth communications interface are further configured to send, to the third network node, a second HTTP response message;
in the third network node:
the third processor and the third communications interface are further configured to receive, from the fourth network node, the second HTTP response message; and
the third processor and the third communications interface are further configured to forward, to the second network node, the second HTTP response message; and
in the second network node:
the second processor and the second communications interface are further configured to receive, from the third network node, the second HTTP response message; and
the second processor and the second communications interface are further configured to forward, to the first network node, the second HTTP response message;
in the first network node:
the first processor and the first communications interface are further configured to receive, from the second network node, the second HTTP response message; and
the first processor and the first communications interface are further configured to perform key exporting; and
in the fourth network node:
the fourth processor and the fourth communications interface are further configured to perform key exporting.

20. The system of claim 16, wherein the first network node is a consumer's Security Edge Protection Proxy (SEPP) (cSEPP), the second network node is a first roaming intermediary (RI) Proxy, the third network node is a second RI Proxy, and the fourth network node is a producer's SEPP (pSEPP).
